(19) United States
(12) Patent Application Publication
(10) Pub. No.: US 2010/0164921 A1
(43) Pub. Date: Jul. 1, 2010

(54) DISPLAY APPARATUS

(75) Inventors: Masumitsu Ino, Kanagawa (JP); Tsutomu Tanaka, Kanagawa (JP); Ryoichi Ito, Kanagawa (JP); Masafumi Kunii, Kumamoto (JP); Hiroyuki Ikeda, Tokyo (JP); Masanobu Ikeda, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/601,480

(22) PCT Filed: Nov. 27, 2008
(86) PCT No.: PCT/JP2008/071526

§ 371 Date: Nov. 23, 2009

(30) Foreign Application Priority Data
Dec. 5, 2007 (JP) 2007-314911
Oct. 20, 2008 (JP) 2008-269590

(51) Int. Cl. G09G 5/10; G06F 3/038

(52) U.S. Cl. 345/207; 345/690

(57) ABSTRACT

Improvement of the image quality and position detection accuracy is implemented. Operation of a backlight 300 to emit illuminating light from one face side of a liquid crystal panel 200 to a display region PA of the liquid crystal panel 200 is controlled based on reception light data obtained by an external light sensor element 32b. Here, the operation of the backlight 300 is controlled based on the reception light data obtained by the external light sensor element 32b disposed in the display region PA.

This application is a 371 U.S. National Stage filing of PCT/JP2008/071526, filed Nov. 27, 2008, which claims priority to Japanese Patent Application Number JP 2007-314911, filed Dec. 5, 2007, and the Japanese Patent Application Number JP 2007-314911, filed Dec. 5, 2007, all of which are incorporated herein by reference.

### TECHNICAL FIELD

This invention relates to a display apparatus. Particularly, the present invention relates to a display apparatus wherein operation of an illuminating section which emits, after light coming in from the other face side of a display panel is received by an external light sensor element to obtain reception light data, illuminating light based on the reception light data obtained by the external light sensor element is controlled by a control section.

### BACKGROUND ART

Display apparatus such as a liquid crystal display apparatus and an organic EL display apparatus have such an advantage that they are slim, light-weighted and low in power consumption.

Among such display apparatus, a liquid crystal display apparatus has a liquid crystal panel as a display panel including a liquid crystal layer filled between a pair of substrates. The liquid crystal panel is, for example, of the transmission type wherein the liquid crystal panel modulates illuminating light emitted from an illuminating apparatus such as a backlight provided on the rear face of the liquid crystal panel and transmits the modulated illuminating light therethrough. Then, display of an image is carried out with the modulated illuminating light on the front face of the liquid crystal panel.

This liquid crystal panel is, for example, of the active matrix type and includes a TFT array substrate on which a plurality of thin film transistors (TFT: Thin Film Transistor) which function as pixel switching elements. In the liquid crystal panel, an opposing substrate is disposed in an opposing relationship so as to face the TFT array substrate, and a liquid crystal layer is provided between the TFT array substrate and the opposing substrate. In this liquid crystal panel of the active matrix type, a pixel switching element inputs a potential to a pixel electrode to vary the voltage to be applied to the liquid crystal layer thereby to control the transmission factor of light which is transmitted through the pixel to modulate the light.

In such liquid crystal panels as described above, a liquid crystal panel has been proposed wherein a light receiving element which receives light to obtain reception light data is built as a position sensor element in a display region in addition to a TFT which functions as a pixel switching element described hereinabove.

Since a liquid crystal panel wherein a light receiving element is built in as a position sensor element as described above can implement a function as a user interface, it is called I/O touch panel (Input-Output touch panel). In a liquid crystal panel of this type, the necessity to separately install a touch panel of the resistance film type or the electric capacitance type on the front face of the liquid crystal panel is eliminated. Therefore, miniaturization of an apparatus can be implemented readily, and a contribution to reduction in thickness of the liquid crystal panel can be made. Further, where a touch panel of the resistance film type or the electric capacitance type is installed, since light to be transmitted through the display region is sometimes decreased by the touch panel or the light suffers from interference, the picture quality of the display image is sometimes deteriorated. However, appearance of this fault can be prevented by building a light receiving element as a position sensor in the liquid crystal panel in such a manner as described above.

In such a liquid crystal panel as described above, visible light of light reflected from a detection object body such as, for example, a finger of a user or a touch pen touching with the front face of the liquid crystal panel is received by light receiving elements built in as position sensor elements. Thereafter, the position at which the detection object body touches is specified based on reception light data obtained by the light receiving elements built in as position sensor elements, and an operation corresponding to the specified position is carried out by the liquid crystal display apparatus itself or by a different electronic apparatus connected to the liquid crystal display apparatus.

Where a light receiving element built in as a position sensor element is used to detect the position of a detection object body as described above, reception light data obtained by the light receiving element sometimes includes much noise by an influence of visible light included in external light. Further, where dark display is carried out in a display region, it is difficult for a light receiving element provided on a TFT array substrate to receive visible light emitted from a detection object body. Therefore, it is sometimes difficult to detect the position accurately.

In order to correct such a fault as described above, a technique has been proposed which uses invisible light such as infrared light other than visible light. Here, a light receiving element built in as a position sensor element receives invisible light such as infrared light to acquire reception light data, and the position of a detection object body is specified based on the acquire data (refer to, for example, Japanese Patent Laid-Open No. 2005-275644, Japanese Patent Laid-Open No. 2004-318819 and Japanese Patent Laid-Open No. 2006-301864).

Further, a technique is known that a light receiving element which functions as an external light sensor for receiving external light including visible light is formed, and operation when an illuminating apparatus such as a backlight emits illuminating light is controlled based on reception light data obtained by the external light sensor element. Here, the light receiving element which functions as an external light sensor element is formed in a peripheral region positioned around a display region of a display panel. For example, if light of a high light illuminance is received by the external light sensor, then the operation of the illuminating apparatus is controlled so that the illuminating apparatus may emit illuminating light of a higher light illuminance. On the other hand, if light of a low light illuminance is received by the external light sensor, then the operation of the illuminating apparatus is controlled so that the illuminating apparatus may emit illuminating light of a lower light illuminance. Consequently, the fault that the quality of the display image is deteriorated by an influence of external light can be corrected, and increase of the power consumption can be suppressed.

However, in the foregoing case, since a light receiving element which functions as an external light sensor element is formed in a peripheral region positioned around a display region of a display panel, it is sometimes difficult to adjust the influence of external light coming into the display region with a high degree of accuracy. Therefore, sometimes it is not easy to correct the fault that the quality of a display image is deteriorated by an influence of external light. Further, since light such as external light undergoes multipath reflection and stray light is sometimes generated, the accuracy in position detection sometimes drops.

In this manner, deterioration of the image quality or deterioration of the position detection accuracy sometimes occurs.

Accordingly, the present invention provides a display apparatus which can implement improvement of the image quality and the position detection accuracy.

### DISCLOSURE OF INVENTION

According to the present invention, there is provided a display apparatus including a display panel having a plurality of pixels disposed in a display region thereof and an illuminating section for emitting illuminating light from one face side of the display panel to the display region, the display apparatus having an external light sensor element for receiving light coming in from the other face side of the display panel and a control section for controlling operation of the illuminating section to emit the illuminating light based on reception light data obtained by reception of the light by the external light sensor element, the external light sensor element being disposed in the display region.

In the present invention, light coming in from the other face side of the display panel is received by the external sensor element in the display region.

According the present invention, a display apparatus which can implement improvement of the image quality and the position detection accuracy can be provided.

### BRIEF DESCRIPTION OF DRAWINGS

FIG. 1 is a sectional view showing a configuration of a liquid crystal apparatus in an embodiment 1 according to the present invention.

FIG. 2 is a plan view showing a liquid crystal panel in the embodiment 1 according to the present invention.

FIG. 3 is a plan view schematically illustrating a manner wherein a light receiving element is disposed as a position sensor element or an external light sensor element in a display region in the embodiment 1 according to the present invention.

FIG. 4 is a sectional view schematically showing an outline of a pixel P provided in the display region of the liquid crystal panel in the embodiment 1 according to the present invention.

FIG. 5 is a plan view schematically showing an outline of the pixel P provided in the display region of the liquid crystal panel in the embodiment 1 according to the present invention.

FIG. 6 is a sectional view showing, in an enlarged scale, a section of a pixel switching element in the embodiment 1 according to the present invention.

FIG. 7 is a sectional view showing an FFS (Field Fringe Switching) structure.

FIG. 8 is a sectional view schematically showing an outline of a pixel provided in the display region of the liquid crystal panel in the embodiment 1 according to the present invention.

FIG. 9 is a sectional view schematically showing an outline of the pixel provided in the display region of the liquid crystal panel in the embodiment 1 according to the present invention.

FIG. 10 is a block diagram conceptually illustrating inputting/outputting of data between principal components of a control section and other members.

FIG. 11 is a circuit diagram illustrating operation when an image is displayed in the embodiment 1 according to the present invention.

FIG. 12 is a sectional view illustrating a manner where the position at which a detection object body is contacted with or is moved in the display region of the liquid crystal panel is detected in the embodiment 1 according to the present invention.

FIG. 13 is a circuit diagram illustrating operation when the detection object body is contacted with or is moved in the display region of the liquid crystal panel in the embodiment 1 according to the present invention.

FIG. 14 is a plan view showing a position sensor circuit provided for detecting the position at which a detection object body is contacted with or moved in the display region of the liquid crystal panel in the embodiment 1 according to the present invention.

FIG. 15 is a circuit diagram illustrating operation when the external light sensor element detects external light in the embodiment 1 according to the present invention.

FIG. 16 is a view illustrating a relationship between the illuminance L (lx) of received external light and the power consumption W (mW) of an infrared light source of a backlight in the embodiment 1 according to the present invention.

FIG. 17 is a view illustrating the intensity of reception light data obtained in a case wherein the external light sensor element is provided in a display region and in another case wherein the external light sensor element is formed in a peripheral region in the embodiment 1 according to the present invention.

FIG. 18 is views illustrating manners wherein external light comes in in the case wherein the external light sensor element is provided in the display region PA and in the case wherein the external light sensor element is formed in the peripheral region in the embodiment 1 according to the present invention.

FIG. 19 is views illustrating manners wherein external light comes in in the case wherein the external light sensor element is provided in the display region PA and in the case wherein the external light sensor element is formed in the peripheral region in the embodiment 1 according to the present invention.

FIG. 20 is views illustrating manners wherein external light comes in in the case wherein the external light sensor element is provided in the display region PA and in the case wherein the external light sensor element is formed in the peripheral region in the embodiment 1 according to the present invention.

FIG. 21 is a view illustrating a relationship between the time and the power consumption W (mW) of an infrared light source of the backlight in the embodiment 1 according to the present invention.

FIG. 22 is an explanatory view regarding a band gap of a silicon semiconductor in an embodiment 2 according to the present invention.

FIG. 23 is views illustrating an effect in carrying out of position coordinate detection using infrared light in the embodiment 2 according to the present invention.

FIG. 24 is a view schematically illustrating a manner wherein a light receiving sensor element is disposed in a display region of a liquid crystal panel in an embodiment 3 according to the present invention.

FIG. 25 is a block diagram conceptually illustrating inputting/outputting of data between principal components of a control section and different members in the embodiment 3 according to the present invention.

FIG. 26 is a sectional view schematically showing an outline of a portion, at which an infrared filter is provided, of a pixel provided in the display region of the liquid crystal panel in the embodiment 3 according to the present invention.

FIG. 27 is a sectional view showing a modified form of the configuration of a pixel switching element in the embodiments according to the present invention.

FIG. 28 is a plan view schematically illustrating a manner wherein a light receiving element is disposed as a position sensor element or an external light sensor element in the display region in the embodiments according to the present invention.

FIG. 29 is plan views schematically illustrating a manner wherein a light receiving element is disposed as a position sensor element or an external light sensor element in the display region in the embodiments according to the present invention.

FIG. 30 is plan views schematically illustrating a manner wherein a light receiving element is disposed as a position sensor element or an external light sensor element in the display region in the embodiments according to the present invention.

FIG. 31 is plan views schematically illustrating a manner wherein a light receiving element is disposed as a position sensor element or an external light sensor element in the display region PA in the embodiments according to the present invention.

FIG. 32 is a view showing an electronic apparatus to which any of the liquid crystal display apparatus of the embodiments according to the present invention is applied.

FIG. 33 is a view showing another electronic apparatus to which any of the liquid crystal display apparatus of the embodiments according to the present invention is applied.

FIG. 34 is a view showing a further electronic apparatus to which any of the liquid crystal display apparatus of the embodiments according to the present invention is applied.

FIG. 35 is a view showing a still further electronic apparatus to which any of the liquid crystal display apparatus of the embodiments according to the present invention is applied.

FIG. 36 is a view showing a yet further electronic apparatus to which any of the liquid crystal display apparatus of the embodiments according to the present invention is applied.

### BEST MODES FOR CARRYING OUT THE INVENTION

Examples of an embodiment according to the present invention are described.

### Embodiment 1

### Configuration of the Liquid Crystal Display Apparatus

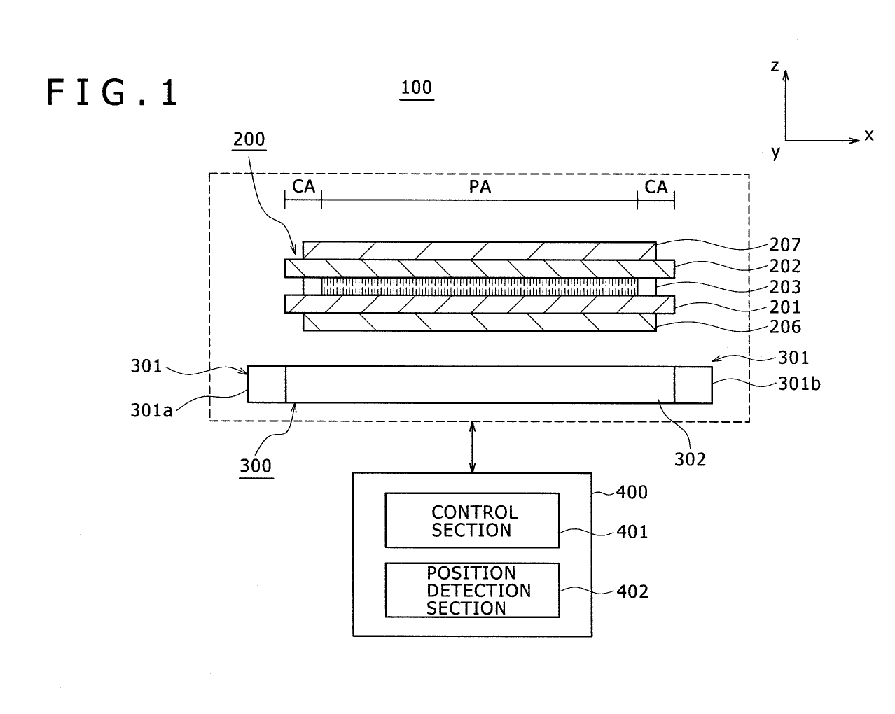

FIG. 1 is a sectional view showing a configuration of a liquid crystal display apparatus 100 in an embodiment 1 according to the present invention.

As shown in FIG. 1, the liquid crystal display apparatus 100 of the present embodiment has a liquid crystal panel 200, a backlight 300 and a data processing section 400. The components are described successively.

The liquid crystal panel 200 is of the active matrix type and has a TFT array substrate 201, an opposing substrate 202 and a liquid crystal layer 203 as shown in FIG. 1.

In this liquid crystal panel 200, the TFT array substrate 201 and the opposing substrate 202 are opposed to each other with a distance placed therebetween. The liquid crystal layer 203 is provided in such a manner as to be sandwiched between the TFT array substrate 201 and the opposing substrate 202.

Further, as shown in FIG. 1, in the liquid crystal panel 200, a first polarizing plate 206 and a second polarizing plate 207 are installed in such a manner as to be opposed to each other on the opposite face sides of the liquid crystal panel 200. Here, the first polarizing plate 206 is disposed on the TFT array substrate 201 side and the second polarizing plate 207 is disposed on the opposing substrate 202 side.

Here, the liquid crystal panel 200 is of the transmission type, and the backlight 300 is disposed in such a manner as to be positioned on the TFT array substrate 201 side. In the liquid crystal panel 200, a face of the TFT array substrate 201 opposite to the face which is opposed to the opposing substrate 202 is illuminated with illuminating light emitted from the backlight 300. This liquid crystal panel 200 includes a display region PA in which a plurality of pixels (not shown) are disposed to display an image. Illuminating light emitted from the backlight 300 disposed on the rear face side of the liquid crystal panel 200 is received from the rear face through the first polarizing plate 206, and the light received from the rear face is modulated in the display region PA. In particular, a plurality of TFTs are provided as pixel switching elements (not shown) in such a manner as to correspond to pixels on the TFT array substrate 201. As the TFTs serving as pixel switching elements are switching controlled to modulate the illuminating light received from the rear face. Then, the modulated illuminating light is emitted to the front face side through the second polarizing plate 207, and an image is displayed in the display region PA.

In the present embodiment, the liquid crystal panel 200 is a so-called I/O touch panel. Therefore, although details are hereinafter described, light receiving elements (not shown) are formed as position sensor elements for detecting the position of a detection object body when the detection object body is contacted with or positioned closely to the front face of the liquid crystal panel 200 on the opposite side to the rear race on which the backlight 300 is disposed. For example, the position sensor elements are formed so as to include a photodiode and are used for detection of the position of a detection object body such as, for example, a finger of a user or a touch pen. The light receiving elements which form the position sensor elements receive, on the front face side of the liquid crystal panel 200, reflection light reflected by the detection object body. In particular, the light receiving elements receive reflected light directed from the opposing substrate 202 side toward the TFT array substrate 201 side. Then, the light receiving elements which form the position sensor elements carry out photoelectric conversion to produce reception light data.

Further, in the present embodiment, although details are hereinafter described, the light receiving elements of the liquid crystal panel 200 which receive external light coming in from the front face side of the liquid crystal panel 200 are formed as external light sensor elements (not shown). For example, the external light sensor elements are formed so as to include a photodiode. Here, the external light sensor element receives external light coming in from the opposing substrate 202 side toward the TFT array substrate 201 side. Then, the light receiving element which forms the external light sensor element carries out photoelectric conversion to produce reception light data.

As shown in FIG. 1, the backlight 300 is opposed to the rear face of the liquid crystal panel 200 and emits illuminating light to the display region PA of the liquid crystal panel 200. Here, as shown in FIG. 1, the backlight 300 has a light source 301 and a light guide plate 302 which diffuses the light illuminated from the light source 301 to convert the light into planar light and irradiates the planar light to the overall area of the display region PA of the liquid crystal panel 200. In particular, the backlight 300 is disposed adjacent the TFT array substrate 201 from between the TFT array substrate 201 and the opposing substrate 202 which compose the liquid crystal panel 200. The planar light is irradiated upon the face of the TFT array substrate 201 on the opposite side to the face which is opposed to the opposing substrate 202. In other words, the backlight 300 illuminates the planar light so as to be directed from the TFT array substrate 201 side to the opposing substrate 202 side.

In the present embodiment, the light source 301 of the backlight 300 includes, for example, a visible light source 301a and an infrared light source 301b as shown in FIG. 1. The visible light source 301a and the infrared light source 301b are provided on the opposite ends of the light guide plate 302 and emit visible light and invisible light as illuminating light. In particular, the visible light source 301a is a white LED and is provided at one end of the light guide plate 302, and irradiates white visible light from an irradiating face thereof. Meanwhile, the infrared light source 301b is an infrared LED and is provided at the other end of the light guide plate 302 in such a manner that an irradiating face thereof is opposed to the irradiating face of the visible light source 301a, and irradiates infrared light from the irradiating face. The white visible light irradiated from the visible light source 301a and the infrared light irradiated from the infrared light source 301b are diffused by the light guide plate 302 and irradiated as planar light to the rear face of the liquid crystal panel 200.

The data processing section 400 has a control section 401 and a position detection section 402 as shown in FIG. 1. The data processing section 400 includes a computer and is configured such that the computer operates as individual sections through a program.

The control section 401 of the data processing section 400 includes a computer and is configured so as to control operation of the liquid crystal panel 200 and the backlight 300. The control section 401 supplies a control signal to the liquid crystal panel 200 to control operation of the plural pixel switching elements (not shown) provided on the liquid crystal panel 200 to display an image in the display region PA of the liquid crystal panel 200. For example, the control section 401 causes the liquid crystal panel 200 to execute line-sequential driving to display an image.

Further, the control section 401 supplies a control signal to the liquid crystal panel 200 to control operation of the plural position sensor elements provided on the liquid crystal panel 200 and serving as the light receiving elements to collect reception light data from the position sensor elements. For example, the control section 401 causes the liquid crystal panel 200 to execute line-sequential driving to collect the reception light data.

Further, the control section 401 supplies a control signal to the liquid crystal panel 200 to control operation of the plural external light sensor elements provided on the liquid crystal panel 200 and serving as the light receiving elements to collect reception light data from the external light sensor elements.

Further, the control section 401 supplies a control signal to the backlight 300 to control operation of the backlight 300 to irradiate illuminating light from the backlight 300.

Here, the control section 401 controls operation of the backlight 300 to emit illuminating light based on the reception light data obtained by reception of light of the external light sensor elements.

Although details are hereinafter described, in the present embodiment, if the reception light data obtained by reception of light of the external light sensor elements indicate that the illuminance of the received light is high, then high power is supplied to the backlight 300 so as to cause the backlight 300 to irradiate illuminating light of a higher illuminance. On the other hand, if the illuminance of the received light is low, then lower power is supplied to the backlight 300 so as to cause the backlight 300 to irradiate illuminating light of a lower illuminance.

The position detection section 402 detects the position of the display region of the liquid crystal panel 200 at which a detection object body is contacted with or positioned closely to the liquid crystal panel 200 based on reception light data collected from the plural light receiving elements provided as the position sensor elements on the liquid crystal panel 200.

### [General Configuration of the Liquid Crystal Panel]

The liquid crystal panel 200 is described in detail.

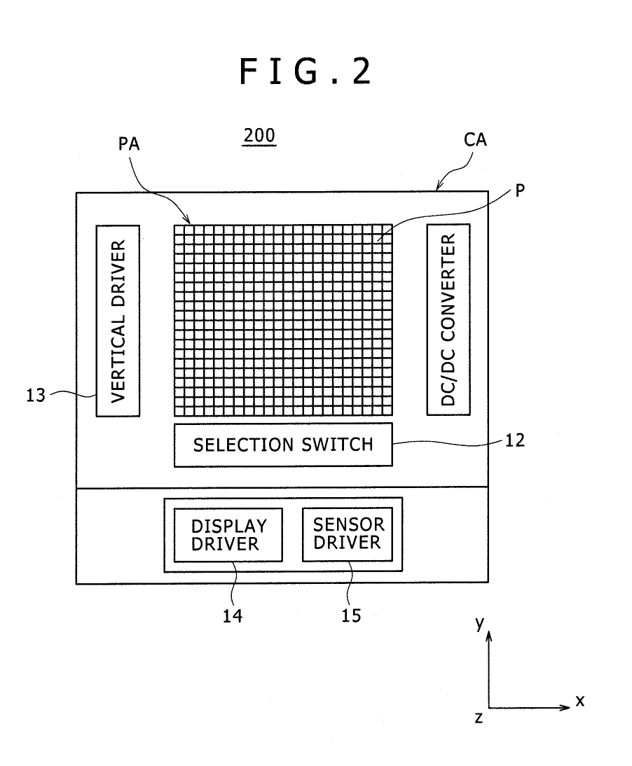

FIG. 2 is a plan view showing the liquid crystal panel 200 in the embodiment 1 according to the present invention.

As shown in FIG. 2, the liquid crystal panel 200 has a display region PA and a peripheral region CA.

In the liquid crystal panel 200, a plurality of pixels P are disposed in a horizontal direction x and a vertical direction y in the display region PA such that they are juxtaposed in a matrix as shown in FIG. 2 to display an image.

Here, each pixel P has a pixel switching element (not shown) formed therein although details are hereinafter described. Further, the pixel P is formed so as to include a light receiving element (not shown) serving as a position sensor element or an external light sensor element.

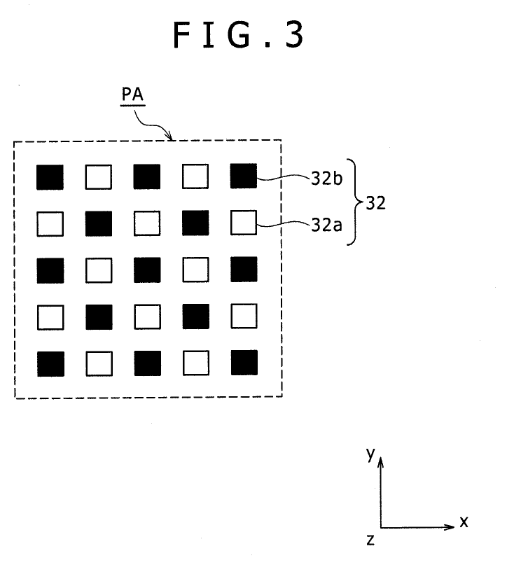

FIG. 3 is a plan view schematically illustrating a manner wherein light receiving elements are disposed each as a position sensor element or an external sensor element in the display region PA in the embodiment according to the present embodiment.

In the present embodiment, as shown in FIG. 3, light receiving elements 32 which function as position sensor elements 32a and external light sensor elements 32b are disposed in the display region PA such that the position sensor elements 32a and the external light sensor elements 32b individually indicate a diced pattern. In particular, the position sensor elements 32a and the external light sensor elements 32b are disposed such that they are individually juxtaposed alternately in each of the horizontal direction x and the vertical direction y.

In the liquid crystal panel 200, the peripheral region CA is provided such that it surrounds the periphery of the display region PA as shown in FIG. 2. In the peripheral region CA, a selection switch 12, a vertical driver 13, a display driver 14 and a sensor driver 15 are formed. The circuits mentioned are formed from TFTs which function as the pixel switching elements described hereinabove and semiconductor elements formed in a similar manner to the light receiving elements 32 which function as the position sensor elements 32a. The circuits drive the pixel switching elements (not shown) provided in the display region PA to execute image display and drive the light receiving elements 32 provided in the display region PA to collect reception light data.

In particular, the selection switch 12 and the vertical driver 13 line-sequentially drive the pixel switching elements (not shown) provided individually for the pixels P in the display region PA based on driving signals supplied thereto from the display driver 14 to carry out image display.

Further, the selection switch 12 and the vertical driver 13 reads out reception light data from the light receiving elements 32 provided as the position sensor elements 32a in the display region PA based on driving signals supplied from the sensor driver 15 and outputs the reception light data to the position detection section 402. Then, the position detection section 402 detects the position in the display region PA of the liquid crystal panel 200 at which a detection object body such as a finger of a user or a touch pen is contacted with or positioned closely to the display region PA based on the reception light data outputted from the position sensor elements 32a.

Similarly, the selection switch 12 and the vertical driver 13 read out reception light data from the light receiving elements 32 provided as the external light sensor elements 32b in the display region PA based on driving signals supplied thereto from the sensor driver 15 and outputs the reception light data to the control section 401. Then, the control section 401 controls operation of the backlight 300 to emit illuminating light based on the reception light data outputted from the external light sensor elements 32b.

### [Configuration of the Display Region of the Liquid Crystal Panel]

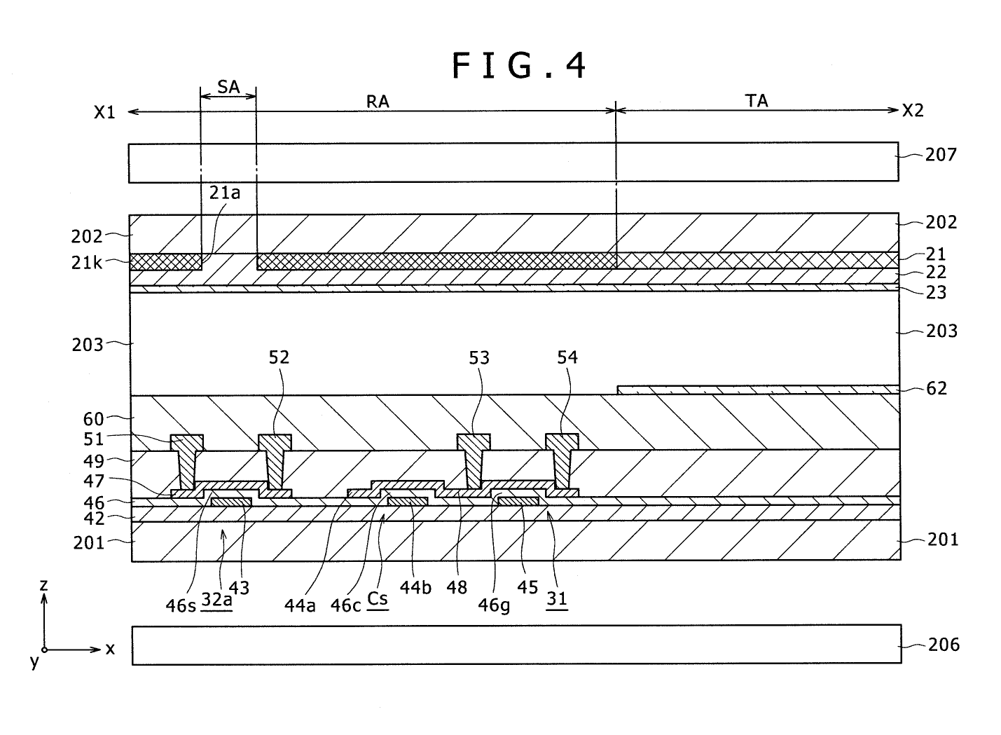

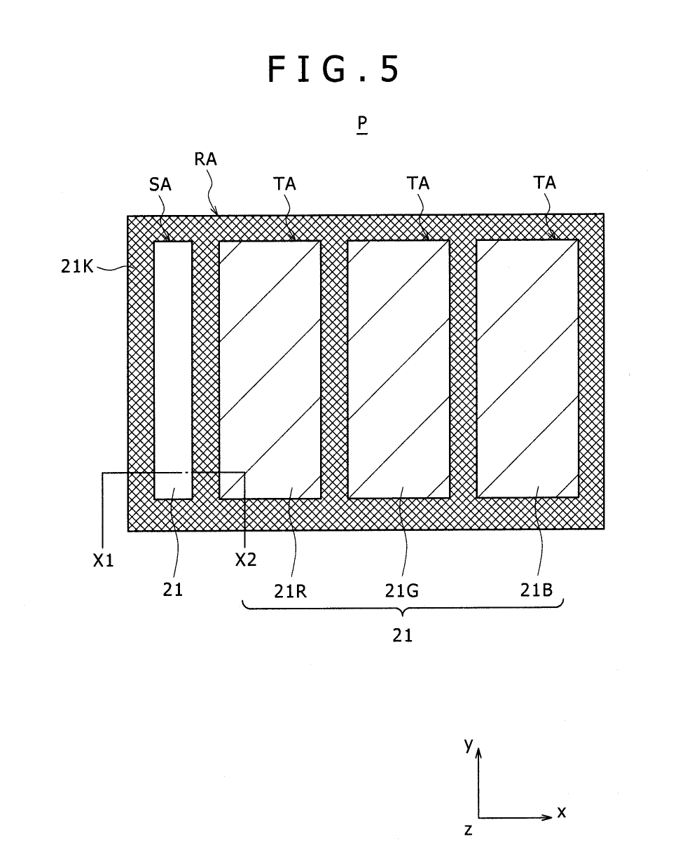

FIG. 4 is a sectional view schematically showing an outline of a pixel P provided in the display region PA of the liquid crystal panel 200 in the embodiment 1 of the present invention. FIG. 5 is a plan view schematically showing an outline of a pixel P provided in the display region PA of the liquid crystal panel 200 in the embodiment of the present embodiment. FIG. 4 shows a portion which corresponds to an X1-X2 portion in FIG. 5 and at which a light receiving elements 32 is formed as a position sensor element 32a in FIG. 3.

As shown in FIG. 4, the liquid crystal panel 200 has a TFT array substrate 201, an opposing substrate 202 and a liquid crystal layer 203. In the liquid crystal panel 200, the TFT array substrate 201 and the opposing substrate 202 are spaced away from each other by a spacer (not shown) and adhered to each other by a seal material (not shown), and the liquid crystal layer 203 is provided in the space between the TFT array substrate 201 and the opposing substrate 202.

Further, as shown in FIGS. 4 and 5, in the liquid crystal panel 200, the pixel P includes a light transmitting region TA and a light blocking region RA.

In the light transmitting region TA, illuminating light emitted from the backlight 300 passes from the TFT array substrate 201 side to the opposing substrate 202 side. Here, in the light transmitting region TA, a color filter layer 21 is formed as shown in FIGS. 3 and 4, and illuminating light emitted from the backlight 300 is colored by the color filter layer 21 and passes from the TFT array substrate 201 side to the opposing substrate 202 side.

Meanwhile, in the light blocking region RA, a black matrix layer 21K is formed as shown in FIGS. 4 and 5, and light illuminated from the backlight 300 is blocked by the black matrix layer 21K around the color filter layer 21.

In this light blocking region RA, a light receiving region SA is formed as shown in FIGS. 4 and 5.

In this light receiving region SA, a light receiving element 32 is formed as a position sensor element 32a so as to receive light advancing from the opposing substrate 202 side toward the TFT array substrate 201 side on a face of the TFT array substrate 201 opposing to the opposing substrate 202. In particular, as shown in FIG. 4, the liquid crystal panel 200 is formed such that light which advances from the opposing substrate 202 side toward the TFT array substrate 201 side and passes through an opening 21a formed in the black matrix layer 21K is received by the position sensor element 32a. The position sensor element 32a which is a light receiving element 32 receives reflection light reflected by a detection object body such as a finger of a user from the opposing substrate 202 side on the front face side of the liquid crystal panel 200 as shown in FIG. 4.

The individual components of the liquid crystal panel 200 are described.

The TFT array substrate 201 is described below.

The TFT array substrate 201 is a substrate of an insulator which passes light therethrough and is formed, for example, from glass. The TFT array substrate 201 has a pixel switching element 31, an auxiliary capacitance element Cs, a position sensor element 32a and a pixel electrode 62 formed on a face thereof opposing to the opposing substrate 202 as shown in FIG. 4.

It is to be noted that, in FIG. 4, a dot region of the color filter layer 21 of the pixel P which corresponds to a red filter layer 21R is shown. Though not shown, in dot regions corresponding to a green filter layer 21G and a blue filter region 21B, other members than the position sensor element 32a are formed in a similar manner as in the case of the dot region corresponding to the red filter layer 21R.

The individual components of the TFT array substrate 201 are described.

The pixel switching element 31 is formed on a face of the TFT array substrate 201 on the side opposing to the opposing substrate 202 with an insulating layer 42 interposed therebetween as shown in FIG. 4.

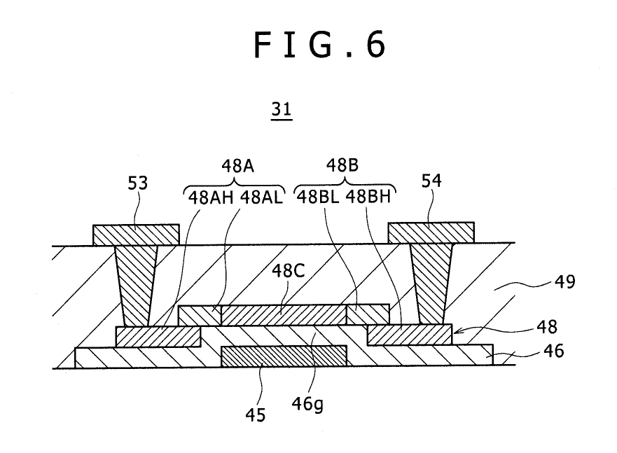

FIG. 6 is a sectional view showing, in an enlarged scale, a cross section of the pixel switching element 31 in the embodiment 1 according to the present invention.

As shown in FIG. 6, the pixel switching element 31 is formed as a bottom gate type TFT of the LDD (Lightly Doped Drain) structure including a gate electrode 45, a gate insulating film 46g and a semiconductor layer 48.

In particular, in the pixel switching element 31, the gate electrode 45 is formed using a metal material such as, for example, molybdenum.

Meanwhile, in the pixel switching element 31, the gate insulating film 46g is formed using an insulating material such as a silicon dioxide film.

Further, in the pixel switching element 31, the semiconductor layer 48 is formed using, for example, low temperature polycrystalline silicon. Further, on the semiconductor layer 48, a channel formation region 48C is formed so as to correspond to the gate electrode 45, and a pair of source-drain regions 48A and 48B are formed in such a manner as to sandwich the channel formation region 48C therebetween. The pair of source-drain regions 48A and 48B have a pair of low-density impurity regions 48AL and 48BL formed thereon in such a manner as to sandwich the channel formation region 48C therebetween. Further, a pair of high-density impurity regions 48AH and 48BH having a higher density of impurities than the source-drain regions 48AL and 48BL are formed in such a manner as to sandwich the pair of low-density impurity regions 48AL and 48BL therebetween.

In the pixel switching element 31, each of the source electrode 53 and the drain electrode 54 is formed by filling a conductive material such as aluminum into an opening provided in an insulating layer 49, which covers the semiconductor layer 48, and carrying out patterning.

The auxiliary capacitance element Cs is formed on a face of the TFT array substrate 201 on the side opposing to the opposing substrate 202 with the insulating layer 42 interposed therebetween as shown in FIG. 4. In the present embodiment, the auxiliary capacitance element Cs is formed such that a dielectric film 46c is sandwiched by an upper electrode 44a and a lower electrode 44b as shown in FIG. 4. Here, the upper electrode 44a is formed at a step similar to that for the gate electrode 45 of the pixel switching element 31. Then, the dielectric film 46c is formed at a step similar to the gate insulating film 46g of the pixel switching element 31, and a lower electrode 44b is formed at a step similar to the semiconductor layer 48. The auxiliary capacitance element Cs is formed in such a manner as to be connected in parallel to static capacitance by the liquid crystal layer 203 and holds charge by a data signal applied to the liquid crystal layer 203.

The position sensor element 32a is a light receiving element 32 and is formed on a face of the TFT array substrate 201 on the side opposing to the opposing substrate 202 with the insulating layer 42 interposed therebetween as shown in FIG. 4. Here, the position sensor element 32a is provided on the TFT array substrate 201 such that it receives light advancing from the opposing substrate 202 side toward the TFT array substrate 201 side through the liquid crystal layer 203 as shown in FIG. 4. This position sensor element 32a is, for example, a PIN sensor including a photodiode of a PIN structure and includes a control electrode 43, an insulating film 46s provided on the control electrode 43 and a semiconductor film 47 opposing to the control electrode 43 with the insulating film 46s interposed therebetween. The position sensor element 32a receives and photoelectrically converts light coming in from the light receiving region SA to produce reception light data, which is read out.

In particular, in the position sensor element 32a, the control electrode 43 is formed using a metal material such as, for example, molybdenum. Meanwhile, the insulating film 46s is formed using an insulating material such as a silicon dioxide film. Further, the semiconductor film 47 is formed from low temperature polycrystalline silicon and is configured such that it has a PIN structure wherein, though not shown in FIG. 4, an i layer of high resistance is interposed between a p layer and an n layer. An anode electrode 51 and a cathode electrode 52 are formed by filling aluminum into openings provided in the insulating layer 49.

The pixel electrode 62 is formed so as to cover an interlayer insulating film 60 formed so as to cover a face of the TFT array substrate 201 opposing to the opposing substrate 202 as shown in FIG. 4. Here, as shown in FIG. 4, the pixel electrode 62 is formed on the interlayer insulating film 60 so as to correspond to the light transmitting region TA and is connected to the liquid crystal layer 203. The pixel electrode 62 is a so-called transparent electrode and is formed, for example, using ITO. The pixel electrode 62 applies a voltage to the liquid crystal layer 203 together with the opposing electrode 23 in order to modulate light illuminated by the backlight 300. It is to be noted that a plurality of such pixel electrodes 62 are disposed in a matrix in the display region PA such that they individually correspond to a plurality of pixels P.

The opposing substrate 202 is described.

The opposing substrate 202 is a substrate of an insulator which passes light therethrough similarly as in the case of the TFT array substrate 201 and is formed from glass. The opposing substrate 202 is opposed in a spaced relationship to the TFT array substrate 201 as shown in FIG. 1. The opposing substrate 202 has a color filter layer 21, a black matrix layer 21K, a flattening film 22 and an opposing electrode 23 formed therein as shown in FIG. 4.

The components of the opposing substrate 202 are described.

The color filter layer 21 is formed on a face of the opposing substrate 202 on the side opposing to the TFT array substrate 201 as shown in FIG. 4. The color filter layer 21 has a red filter layer 21R, a green filter layer 21G and a blue filter region 21B formed thereon in an opposing relationship to the light transmitting regions TA as shown in FIG. 5. Here, the red filter layer 21R, green filter layer 21G and blue filter region 21B individually have a rectangular shape and are formed so as to be juxtaposed with each other in the horizontal direction x. The color filter layer 21 is formed using, for example, a polyimide resin which includes a coloring agent such as a pigment or a dye. Here, the color filter layer 21 is formed such that the three primary colors of red, green and blue form one set. The color filter layer 21 colors illuminating light irradiated from the backlight 300.

The black matrix layer 21K is formed in the light blocking region RA such that it defines a plurality of pixels P in the display region PA as shown in FIG. 4 and blocks light. Here, the black matrix layer 21K is formed on a face of the opposing substrate 202 on the side opposing to the TFT array substrate 201. Further, the black matrix layer 21K has an opening 21a formed therein corresponding to the light receiving region SA in such a manner as to allow light to pass therethrough. In short, as shown in FIGS. 4 and 5, the black matrix layer 21K is formed so as to correspond to a region of the light blocking region RA other than the light receiving region SA. For example, the black matrix layer 21K is formed using a metal oxide film of black.

The flattening film 22 is formed on a face of the opposing substrate 202 on the side opposing to the TFT array substrate 201 in such a manner as to correspond to the light transmitting region TA and the light blocking region RA as shown in FIG. 4. Here, the flattening film 22 is formed from a transparent insulating material. The flattening film 22 covers the color filter layer 21 and the black matrix layer 21K to flatten the face side of the opposing substrate 202 on the side opposing to the TFT array substrate 201.

The opposing electrode 23 is formed on a face of the opposing substrate 202 on the side opposing to the TFT array substrate 201 as shown in FIG. 4. Here, the opposing electrode 23 is formed so as to cover the flattening film 22. The opposing electrode 23 is a so-called transparent electrode and is formed, for example, using ITO. The opposing electrode 23 is opposed to a plurality of pixel electrodes 62 and functions as a common electrode.

The liquid crystal layer 203 is described.

The liquid crystal layer 203 is sandwiched between the TFT array substrate 201 and the opposing substrate 202 as shown in FIG. 4 and is in an orientation processed state. For example, the liquid crystal layer 203 is filled in a gap between the TFT array substrate 201 and the opposing substrate 202 between which a predetermined distance is kept by a spacer (not shown). The liquid crystal layer 203 is oriented by liquid crystal orientation films (not shown) formed on the TFT array substrate 201 and the opposing substrate 202. For example, the liquid crystal layer 203 is formed so that liquid crystal molecules are oriented vertically.

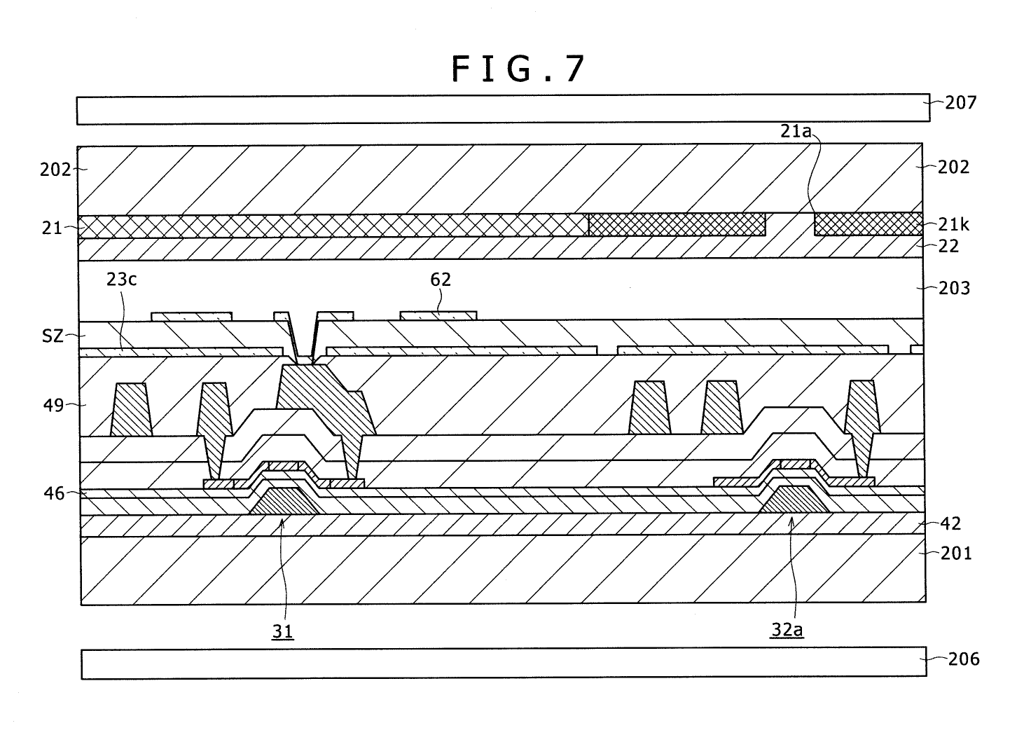

It is to be noted that, to the liquid crystal panel 200, an FFS (Field Fringe Switching) structure which is one of transverse electric field modes can be applied as an example of an application as shown in FIG. 7 in addition to the structure described above. Here, the liquid crystal layer 203 is formed such that liquid crystal molecules are oriented horizontally. Further, in place of the opposing electrode 23 described above, a common electrode 23c is formed, for example, from ITO on the TFT array substrate 201. An interlayer insulating film Sz is formed so as to cover the common electrode 23c, and a pixel electrode 62 is formed on the interlayer insulating film Sz. In other words, both of the pixel electrode 62 and the common electrode 23c are formed on the TFT array substrate 201 and configured such that a voltage is applied to the liquid crystal layer 203 through a transverse electric field.

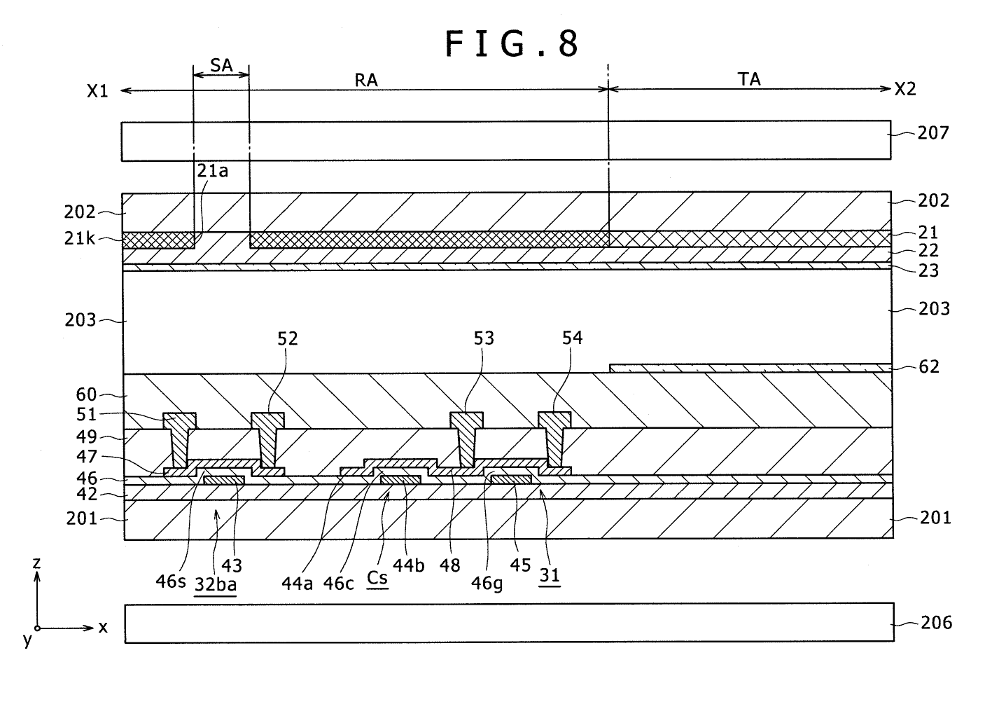

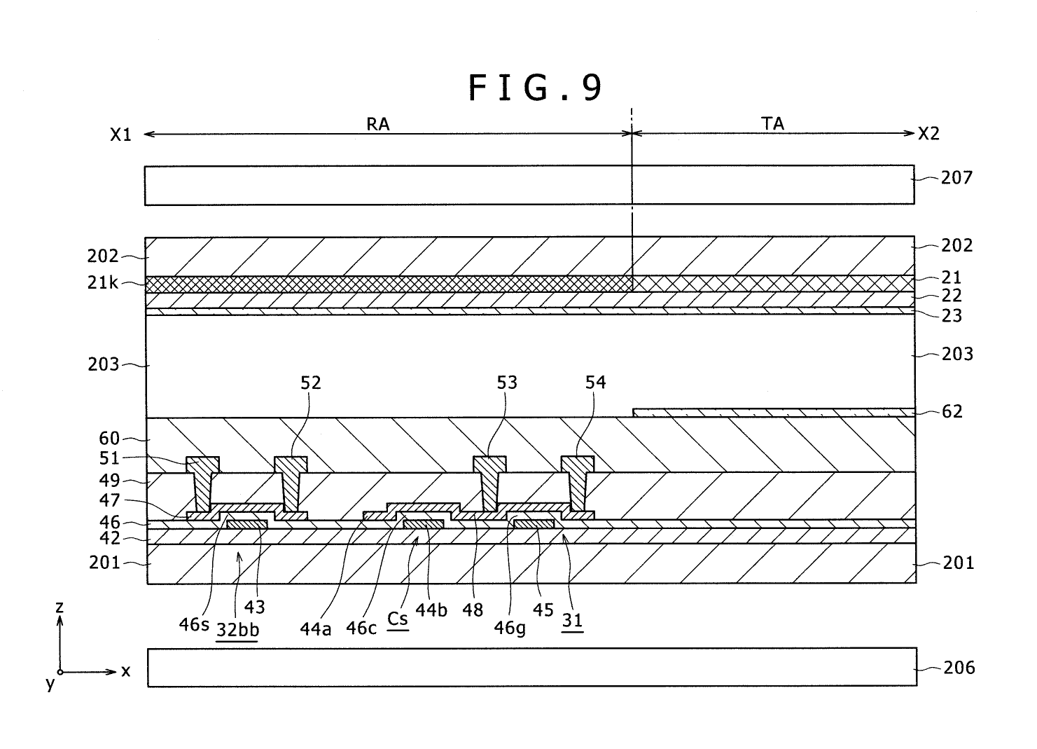

FIGS. 8 and 9 are sectional views schematically showing an outline of a pixel P provided in the display region PA of the liquid crystal panel 200 in the embodiment 1 of the present invention. While FIGS. 8 and 9 show a portion corresponding to an X1-X2 portion in FIG. 5, different from the case of FIG. 4, the light receiving element 32 is formed not as a position sensor element 32a but as an external light sensor element 32b. Further, FIG. 8 shows a first external light sensor element 32ba which is one of the plural external light sensor elements 32b. Meanwhile, FIG. 9 shows a second external light sensor element 32bb formed separately from the external light sensor elements 32ba shown in FIG. 8 from among the plural external light sensor elements 32b shown in FIG. 3.

As shown in FIGS. 8 and 9, in the present embodiment, the first external light sensor element 32ba and the second external light sensor element 32bb are formed as the external light sensor elements 32b.

As shown in FIG. 8, the first external light sensor element 32ba is formed on a face of the TFT array substrate 201 on the side opposing to the opposing substrate 202 with the insulating layer 42 interposed therebetween similarly to the position sensor element 32a shown in FIG. 4. In particular, the first external light sensor element 32ba is, for example, a PIN sensor and is provided on the TFT array substrate 201 such that it receives light advancing from the opposing substrate 202 side toward the TFT array substrate 201 side through the liquid crystal layer 203 as shown in FIG. 8. The first external light sensor element 32ba receives and photoelectrically converts natural light coming in as external light from the light receiving region SA to produce reception light data.

As shown in FIG. 9, the second external light sensor element 32bb is formed on a face of the TFT array substrate 201 on the side opposing to the opposing substrate 202 with the insulating layer 42 interposed therebetween similarly to the position sensor elements 32a shown in FIG. 4. For example, the second external light sensor element 32bb is provided in a juxtaposed relationship with and adjacent each other in the horizontal direction x with the external light sensor element 32ba (not shown in FIG. 9) described above. In particular, the second external light sensor element 32bb is, for example, a PIN sensor and is provided on the TFT array substrate 201 such that it receives light advancing from the opposing substrate 202 side to the TFT array substrate 201 side through the liquid crystal layer 203 as shown in FIG. 9. However, different from the case of the position sensor element 32a or the first external light sensor element 32ba, in a region of the opposing substrate 202 which corresponds to the second external light sensor element 32bb, the light receiving region SA is not provided and light advancing from the opposing substrate 202 side toward the TFT array substrate 201 side is blocked. Therefore, the second external light sensor element 32bb receives and photoelectrically converts light leaking in the light blocking region RA to produce reception light data.

### [Configuration of the Control Section]

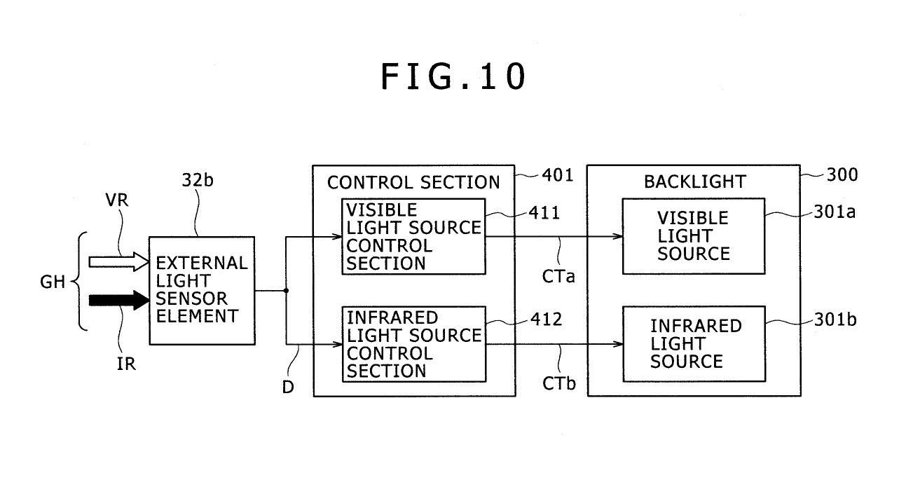

FIG. 10 is a block diagram conceptually illustrating inputting/outputting of data between principal components of the control section 401 and other members in the embodiment 1 according to the present embodiment.

As shown in FIG. 10, in the present embodiment, the control section 401 includes a visible light source control section 411 and an infrared light source control section 412. In other words, the control section 401 is configured such that a computer functions as the visible light source control section 411 and the infrared light source control section 412 based on a program.

The visible light source control section 411 of the control section 401 is configured so as to control the visible light source 301a based on reception light data D obtained by reception of light by the external light sensor element 32b to cause the visible light source 301a to emit visible light.

As shown in FIG. 10, the visible light source control section 411 receives reception light data D obtained by reception of light by the external light sensor element 32b which receives external light GH including visible light VR and infrared light IR. Although details are hereinafter described, in the present embodiment, the reception light data D is produced using reception light data obtained by the first external light sensor element 32ba and the second external light sensor element 32bb which form the external light sensor elements 32b. Thereafter, the visible light source control section 411 outputs control data CTa to the visible light source 301a in response to the reception light data D. Here, the visible light source control section 411 controls such that, when the luminance of the received light is high, the visible light source 301a irradiates visible light of a higher luminance, but when the luminance of the received light is low, the visible light source 301a irradiates visible light of a lower luminance.

For example, the visible light source control section 411 stores, in a memory (not shown) thereof, a lookup table wherein the reception light data D and the control data CTa representative of a value of power to be supplied to the visible light source 301a are associated with each other. The visible light source control section 411 uses the lookup table, and the visible light source control section 411 controls. In particular, the visible light source control section 411 carries out, after it acquires the reception light data D, a data process of extracting control data CTa corresponding to the reception light data D from the lookup table. Then, the visible light source control section 411 controls operation of the visible light source 301a based on the extracted control data CTa.

The infrared light source control section 412 of the control section 401 is configured so as to control operation of the infrared light source 301b of the backlight 300 to emit infrared light based on reception light data D obtained by reception of light by the external light sensor element 32b as shown in FIG. 10.

As shown in FIG. 10, the infrared light source control section 412 receives reception light data D obtained by reception of external light GH, which includes visible light VR and infrared light IR, by the external light sensor element 32b. Thereafter, the infrared light source control section 412 outputs control data CTb to the infrared light source 301b in response to the reception light data D. Here, the infrared light source control section 412 controls such that, when the illuminance of the received light is high, the infrared light source 301b irradiates infrared light of a higher luminance, but when the illuminance of the received light is low, the infrared light source 301b emits infrared light of a lower luminance.

For example, the infrared light source control section 412 stores, in a memory (not shown) thereof, a lookup table wherein control data CTb representative of a value of power to be supplied to the infrared light source 301b and reception light data D are associated with each other. The infrared light source control section 412 uses this lookup table, and the visible light source control section 411 controls. In particular, the infrared light source control section 412 carries out, after it acquires the reception light data D, a data process of extracting control data CTb corresponding to the reception light data D from the lookup table. Then, the infrared light source control section 412 controls operation of the infrared light source 301b based on the extracted control data CTb.

### [Image Display Operation]

In the following, operation of the liquid crystal display apparatus 100 described above when it displays an image is described.

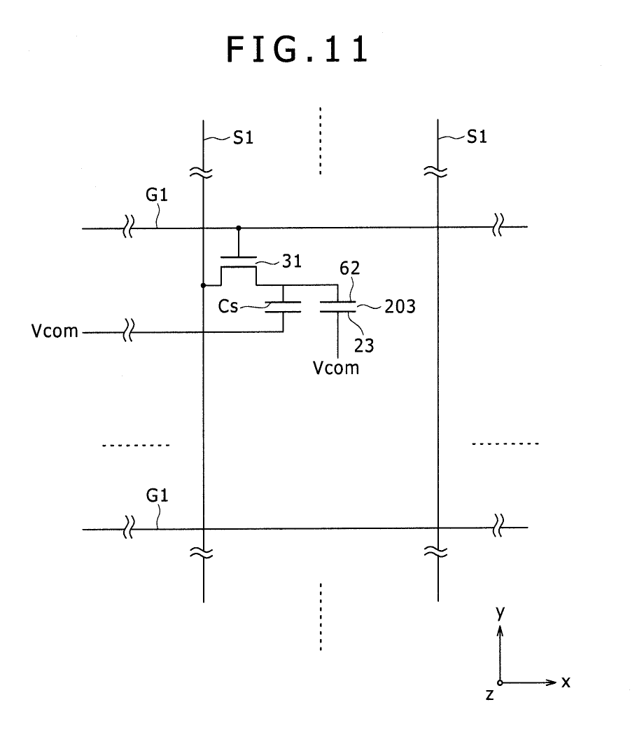

FIG. 11 is a circuit diagram illustrating operation when an image is displayed in the embodiment 1 according to the present invention.

As shown in FIG. 11, a pixel switching element 31 and an auxiliary capacitance element Cs are provided in the proximity of an intersecting point of a data line S1 extending in the vertical direction y in the display region PA and a gate line G1 extending in the horizontal direction x in the display region PA. The pixel switching element 31 is connected at the gate electrode thereof to the gate line G1, at the source electrode thereof to the data line S1 and at the drain electrode thereof to the auxiliary capacitance element Cs and the liquid crystal layer 203. Meanwhile, the auxiliary capacitance element Cs is connected at one electrode thereof to an auxiliary capacitance line and at the other electrode thereof to the source electrode of the pixel switching element 31 as shown in FIG. 11. Further, the gate line G1 is connected to the vertical driver 13 and the data line S1 is connected to the selection switch 12 which functions as a horizontal driver as shown in FIG. 11.

Therefore, when an image is to be displayed, a selection pulse is supplied from the vertical driver 13 to the gate line G1 to place the pixel switching element 31 into an on state. Together with this, an image signal is supplied from the selection switch 12 to the data line S1, and the pixel switching element 31 writes the image signal into the auxiliary capacitance element Cs and the liquid crystal layer 203. In other words, a voltage is applied to the liquid crystal layer 203. Consequently, the direction of liquid crystal molecules in the liquid crystal layer 203 varies, and illuminating light emitted from the backlight is modulated by and passes through the liquid crystal layer 203. Therefore, image display is carried out on the front face of the liquid crystal panel.

### [Position Detection Operation]

In the following, operation of the liquid crystal display apparatus 100 described above when it detects a position with or to which a detection object body such as a finger of a user is contacted or moved in the display region PA of the liquid crystal panel 200 is described.

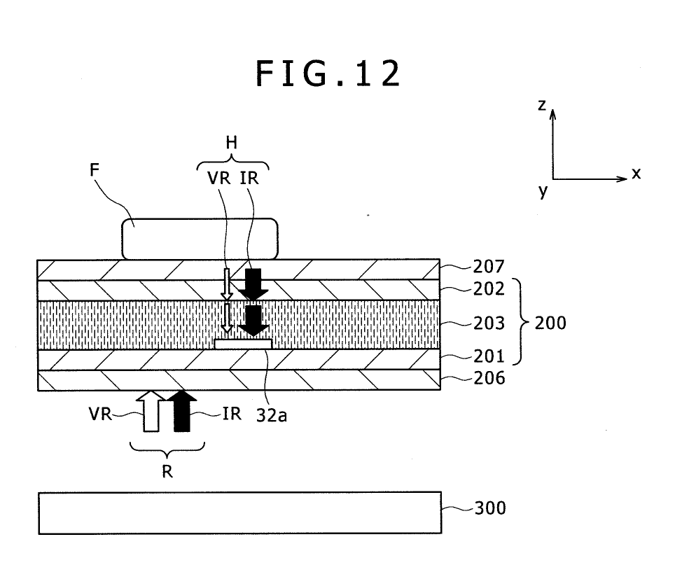

FIG. 12 is a sectional view illustrating a manner when the position with or to which a detection object body is contacted or moved in the display region PA of the liquid crystal panel 200 is detected in the embodiment 1 according to the present invention.

If a detection object body F such as a finger of a user is contacted with or moved to the display region PA of the liquid crystal panel 200, then reflection light reflected by the detection object body F is received by the position sensor elements 32a formed on the liquid crystal panel 200 as shown in FIG. 12.

Here, the backlight 300 irradiates illuminating light R including visible light VR and infrared light IR as planar light upon the rear face of the liquid crystal panel 200. Then, the illuminating light R is irradiated upon the detection object body F through the liquid crystal panel 200 and is reflected by the detection object body F. Then, the reflection light H reflected by the detection object body F is received by the position sensor elements 32a.

At this time, the visible light VR in the illuminating light R is absorbed by various portions of the liquid crystal panel 200 and received in a state wherein the intensity thereof is decreased by the position sensor elements 32a. In contrast, the infrared light IR in the illuminating light R is received in an intensity higher than that of the visible light VR by the position sensor elements 32a because the ratio at which it is absorbed by various portions of the liquid crystal panel 200 is lower than that of the visible light VR.

Then, after reception light data of a signal intensity corresponding to the intensity of the received light are produced by the position sensor elements 32a, the reception light data are read out by the peripheral circuits. Then, the position at which the detection object body F contacts with the display region PA is detected by the position detection section 402 (refer to FIG. 1) based on the positions of the position sensor elements 32a from which the reception data are read out and the signal intensity of the reception light data read out from the position sensor elements 32a.

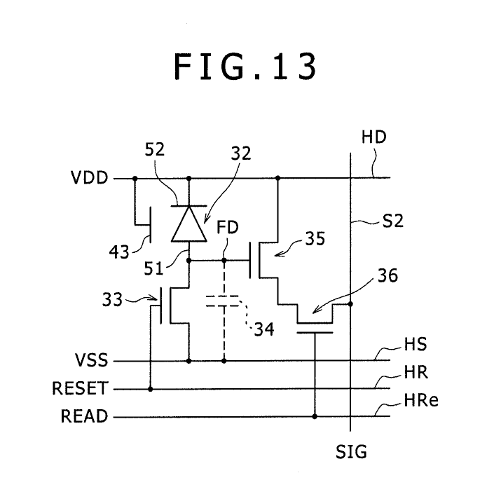

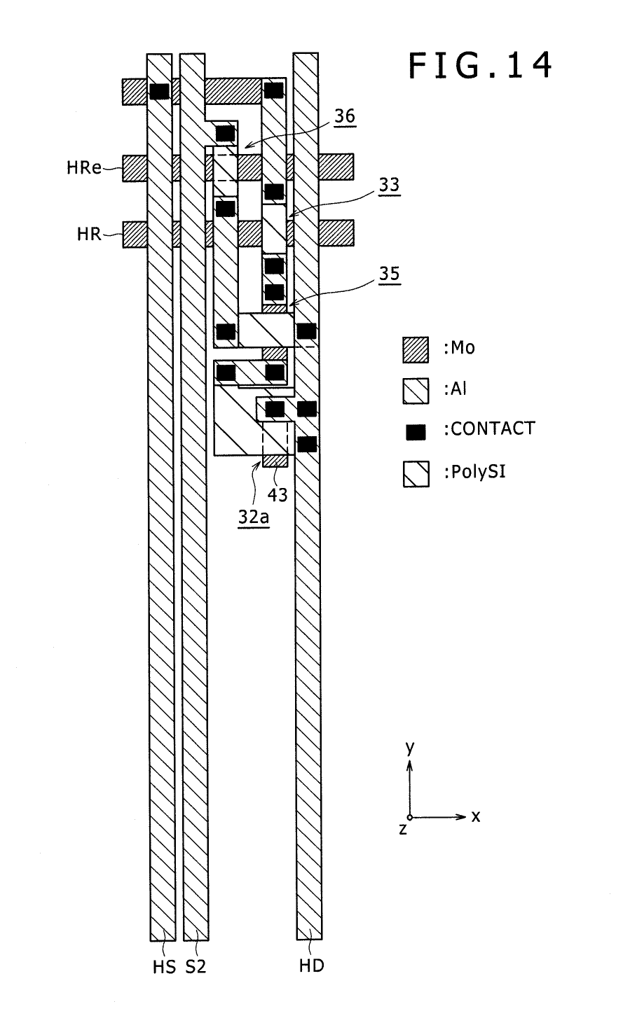

FIG. 13 is a circuit diagram illustrating operation when the position with or to which the detection object body is contacted or moved in the display region PA of the liquid crystal panel 200 is detected in the embodiment 1 according to the present invention. FIG. 14 is a plan view schematically showing a configuration of a position sensor circuit provided for detecting the position with or to which the detection object body is contacted or moved in the display region PA of the liquid crystal panel 200 in the embodiment 1 according to the present invention. In FIG. 14, different slanting lines are applied in accordance with materials from which the members are formed and positions of contacts which couple the members are shown as indicated by keys.

As shown in FIGS. 13 and 14, in the present embodiment, a reset transistor 33, an amplification transistor 35 and a selection transistor 36 are provided in the display region PA in addition to a position sensor element 32a which is a light receiving element. Here, a position sensor circuit is formed from the position sensor element 32a, reset transistor 33, amplification transistor 35 and selection transistor 36.

Here, in the position sensor element 32a which is a light receiving element, the control electrode 43 is connected to a power supply voltage line HD formed from aluminum (Al), and a power supply voltage VDD is supplied. Meanwhile, an anode electrode 51 is connected to a floating diffusion FD. Further, a cathode electrode 52 is connected to the power supply voltage line HD, and the power supply voltage VDD is supplied.

Further, the reset transistor 33 is a TFT including a gate electrode, for example, of molybdenum and a semiconductor layer of polycrystalline silicon. The reset transistor 33 is connected at one of terminals thereof to a reference voltage line HS formed from aluminum (Al), and a reference voltage VSS is supplied. Further, the reset transistor 33 is connected at the other terminal thereof to the floating diffusion FD. The reset transistor 33 is connected at the gate thereof to a reset signal line HR formed from aluminum (Al), and resets the potential of the floating diffusion FD when a reset signal is applied to the gate electrode.

The amplification transistor 35 is a TFT including a gate electrode, for example, of molybdenum and a semiconductor layer of polycrystalline silicon and is connected at one of terminals thereof to the power supply voltage line HD such that the power supply voltage VDD is supplied. The amplification transistor 35 is connected at the other terminal thereof to the selection transistor 36. Further, the amplification transistor 35 is connected at the gate electrode thereof to the floating diffusion FD and forms a source follower circuit.

The selection transistor 36 is, for example, a TFT including a gate electrode of molybdenum and a semiconductor layer of polycrystalline silicon, and is connected at one of terminals thereof to the amplification transistor 35 and at the other terminal thereof to a data line S2. Further, the gate electrode is connected to a readout line HRe formed from aluminum (Al) such that a readout signal (Read) is supplied. The selection transistor 36 is configured such that, if the readout signal is supplied to the gate electrode, then it is placed into an on state and outputs reception light data amplified by the amplification transistor 35 to the data line S2.

Here, capacitance 34 is generated between the floating diffusion FD and the reference voltage line HS to which the reference voltage VSS is applied, and the voltage of the floating diffusion FD varies in response to the amount of charge accumulated in the capacitance 34.

In the present embodiment, the sensor driver 15 outputs driving signals to the selection switch 12 and the vertical driver 13 to drive the position sensor circuit so that reception light data is read out from the light receiving elements 32 provided as the position sensor elements 32a in the display region PA and outputted to the position detection section 402 (refer to FIGS. 1 and 2). In particular, the vertical driver 13 successively supplies a reset signal (Reset) through the reset signal line HR and further supplies the readout signal (Read) successively through the readout line HRe. Then, the selection switch 12 successively reads out reception light data through the data line S2. Then, the position with or to which the detection object body such as a finger of a user or a touch pen is contacted or moved in the display region PA of the liquid crystal panel 200 is detected by the position detection section 402 based on the reception light data outputted from the position sensor elements 32a.

### [Backlight Controlling Operation]

In the following, operation of the liquid crystal display apparatus 100 described above when it detects external light and controls the backlight 300 is described.

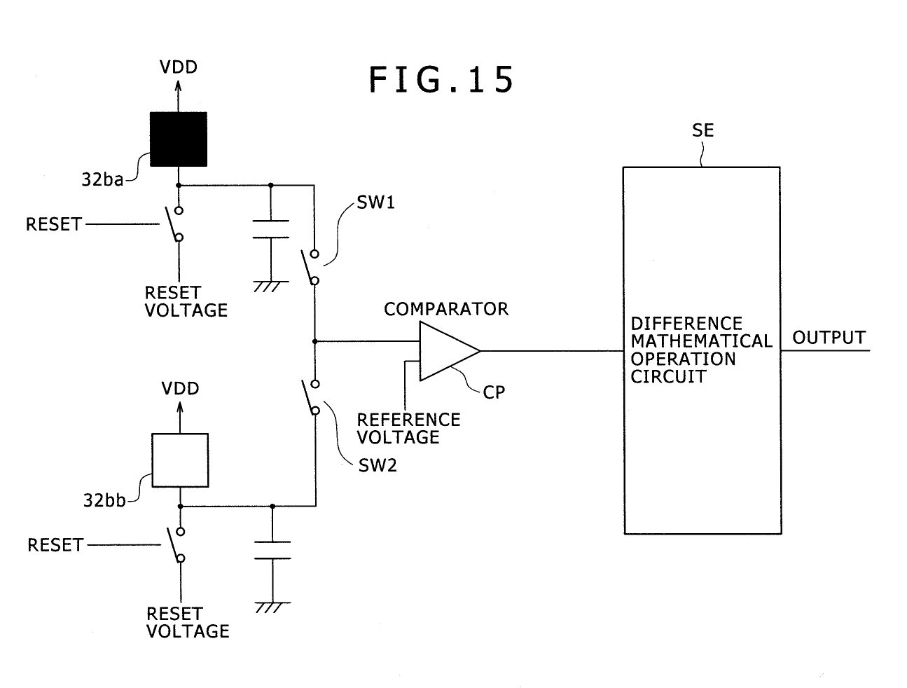

FIG. 15 is a circuit diagram illustrating operation when an external light sensor element detects external light in the embodiment 1 according to the present invention.

As shown in FIG. 15, in the present embodiment, reception light data by the first external light sensor element 32ba which receives external light coming in from the light receiving region SA and reception light data by the second external light sensor element 32bb which receives light leaking from the light blocking region RA are used to detect external light. Further, the sensor driver 15 (refer to FIG. 2) has switches SW1 and SW2 for changing over between the first external light sensor element 32ba and the second external light sensor element 32bb, a comparator (comparator) CP and a difference mathematical operation circuit SE. Here, outputting of reception light data by the first external light sensor element 32ba and reception data by the second external light sensor element 32bb is changed over by the switches SW1 and SW2 and the same comparator CP is used to read out the output time-divisionally. Then, the difference mathematical operation circuit SE outputs difference data between the reception light data by the first external light sensor element 32ba and the reception light data by the second external light sensor element 32bb. Therefore, it is possible to remove an error of the comparator CP, and also it is possible to achieve an effect of circuit area reduction.

In particular, the switch SW1 of the first external light sensor element 32ba is turned OFF, and the switch SW2 of the second external light sensor element 32bb is turned ON. In this state, resetting of the second external light sensor element 32bb is turned ON/OFF once to detect light to obtain reception light data. Since the second external light sensor element 32bb is in a light blocked state, it measures dark current in the light blocked state, and reception light data of the second external light sensor element 32bb is transmitted to the comparator CP.

Then, time (for example, the number of steps) until after the detection value of reception light data after start of light reception by the second external light sensor element 32bb exceeds a predetermined reference value is counted by the difference mathematical operation circuit SE and stored into the memory.

Then, the switch SW2 of the second external light sensor element 32bb is turned OFF and the switch SW1 of the first external light sensor element 32ba is turned ON. In this state, resetting of the first external light sensor element 32ba is turned ON/OFF once to detect light to obtain reception light data. Since the first external light sensor element 32ba is not in a light blocked state and can receive external light, current when light is not blocked to the comparator CP is measured. Then, the reception light data is transmitted to the comparator CP.

Then, the difference mathematical operation circuit SE counts the time (for example, the number of steps) until after the detection value of the reception light data after reception of light of the first external light sensor element 32ba is started exceeds a predetermined reference value and stores the time into the memory.

Then, the detection result of the first external light sensor element 32ba and the detection result of the second external light sensor element 32bb stored in the memory of the difference mathematical operation circuit SE are read out. Then, the difference mathematical operation circuit SE carries out a difference mathematical operation process of subtracting the detection result of the second external light sensor element 32bb from the detection result of the first external light sensor element 32ba and outputs difference data. In other words, the difference mathematical operation circuit SE outputs difference data obtained by subtracting the dark current from the detection result when light is not blocked.

Then, the control section 401 receives the difference data as reception light data D obtained by the external light sensor element 32b (refer to FIG. 10) and controls operation of the backlight 300. In particular, when the difference data is great, since the intensity of the received external light is high, the control section 401 controls the backlight 300 to irradiate illuminating light of a higher intensity. On the other hand, if the difference data is small, then since the intensity of the received light is low, the control section 401 controls the backlight 300 so as to irradiate illuminating light of a lower intensity. In this manner, the reception light data obtained by the two external light sensor elements 32ba and 32bb are compared with each other by the single comparator CP, and the control section 401 controls operation of the backlight 300 based on difference data obtained by difference calculation using the value obtained by the comparison. Therefore, since an influence of the dispersion in characteristic of the comparator CP is not given and the S/N ratio is improved, light amount detection can be carried out with certainty.

In the present embodiment, operation of the infrared light source 301b of the backlight 300 is controlled based on the difference data obtained as the reception light data D of the external light sensor element 32b as described hereinabove with reference to FIG. 10.

For example, if the illuminance of received external light is high, then the infrared light source control section 412 carries out control so that the infrared light source 301b irradiates infrared light of a higher luminance. On the other hand, if the illuminance of the received external light is low, then the infrared light source control section 412 carries out control so that the infrared light source 301b irradiates infrared light of a lower luminance.

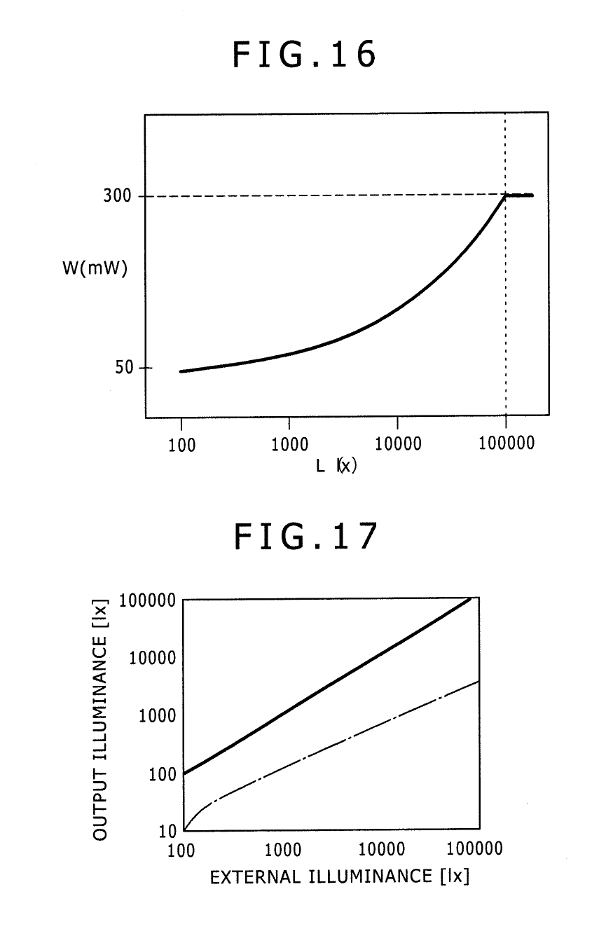

FIG. 16 is a view illustrating a relationship between the illuminance L (lx) of received external light and the power consumption W (mW) of the infrared light source 301b of the backlight 300 in the embodiment 1 according to the present invention. Here, values estimated in a case wherein the liquid crystal panel is a 3.5 type WVGA are illustrated.

As shown in FIG. 16, for example, if the illuminance L of external light is 100 lx, then power of 50 mW is supplied to the infrared light source 301b of the backlight 300. On the other hand, for example, if the illuminance L of external light is 10,000 lx, then power of 125 mW is supplied to the infrared light source 301b of the backlight 300. In this manner, if the light amount is lower than a detection limit of the external light sensor element 32b and is within an operation region (for example, within a region from 100 to 1,000,000 lx) within which external light comes in, then the power is supplied to the infrared light source 301b of the backlight 300 in response to the light amount. It is to be noted that, if light of a light amount exceeding the detection limit of the external light sensor element 32b is within a saturation luminance region (for example, within a region exceeding 100,000 lx) supplied from external light, then fixed power of, for example, 300 mW is supplied.

Further, in the present embodiment, in addition to the infrared light source 301b of the backlight 300, control of operation of the visible light source 301a of the backlight 300 is carried out by the visible light source control section 411 based on difference data obtained as reception light data D of the external light sensor element 32b in such a manner as described above. The visible light source control section 411 controls such that, though not shown, if the illuminance of the received light is high, then the visible light source 301a irradiates visible light of a higher luminance, but if the illuminance of the received light is low, then the visible light source 301a irradiates visible light of a lower luminance.

As described above, in the present embodiment, the external light sensor elements 32b including the first external light sensor element 32ba and the second external light sensor element 32bb are disposed in the display region PA as shown in FIG. 3. Therefore, in the present embodiment, the S/N ratio is improved in comparison with that in an alternative case wherein the external light sensor elements 32b are provided in the peripheral region CA.

FIG. 17 is a view illustrating the intensity of reception light data obtained in a case wherein the external light sensor elements 32b are formed in the display region PA and in another case wherein the external light sensor elements 32b are formed in the peripheral region CA in the embodiment 1 according to the present invention. In FIG. 17, the axis of abscissa indicates the illuminance (lx) of external light, and the axis of ordinate indicates reception light data obtained by the external light sensor elements 32b when they receive the external light as an output illuminance which is an external light illumination conversion value of the reception light data. In this FIG. 17, the output illuminance in the case wherein the external light sensor elements 32b are formed in the display region PA is indicated by a solid line, and the output illuminance in the case wherein the external light sensor elements 32b are formed in the peripheral region CA is indicated by a broken line.

As illustrated in FIG. 17, if external light of 1,000 lx comes in, then where the external light sensor elements 32b are formed in the peripheral region CA, reception light data corresponding to an illuminance of approximately 100 lx is obtained. In contrast, where the external light sensor elements 32b are formed in the display region PA, reception light data corresponding to an illuminance of 1,000 lx is obtained. In this manner, by providing the external light sensor elements 32b in the display region PA, light of a high intensity can be received.

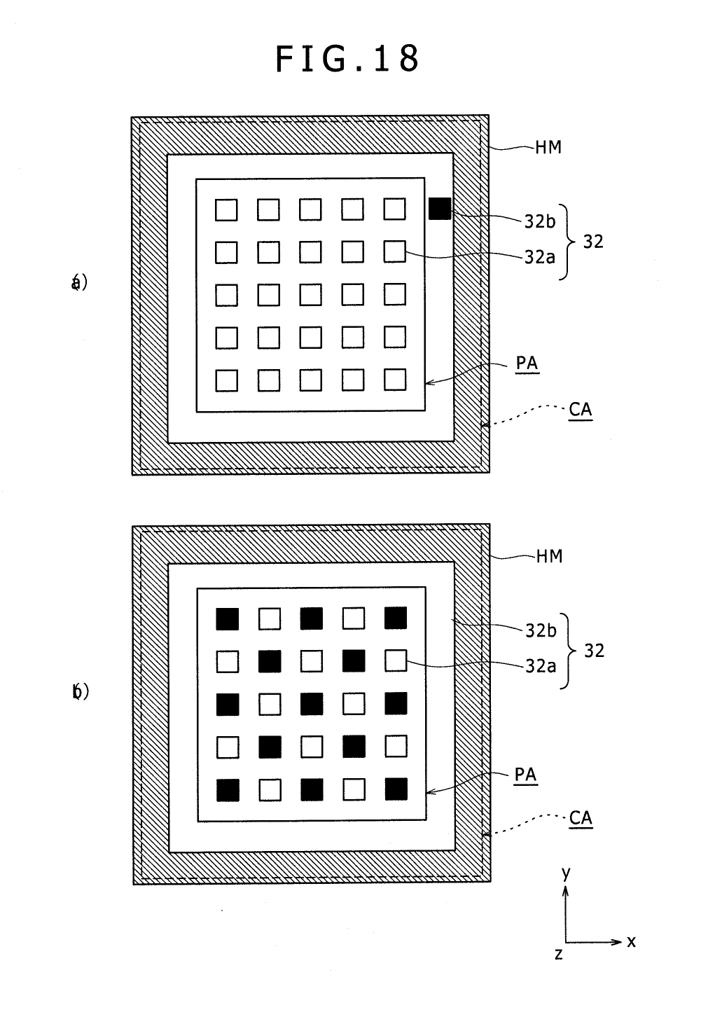

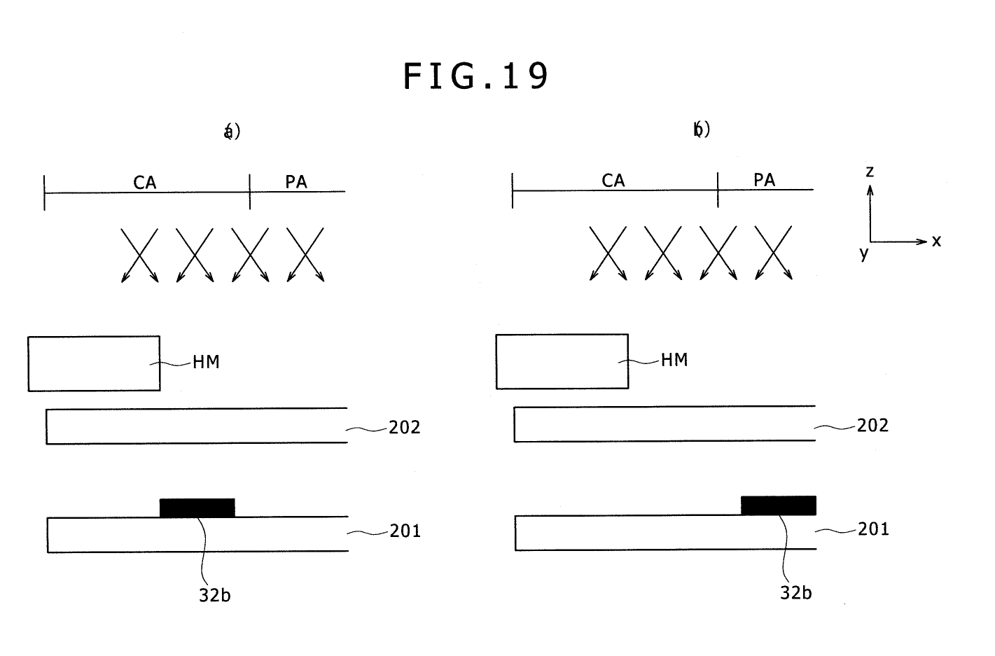

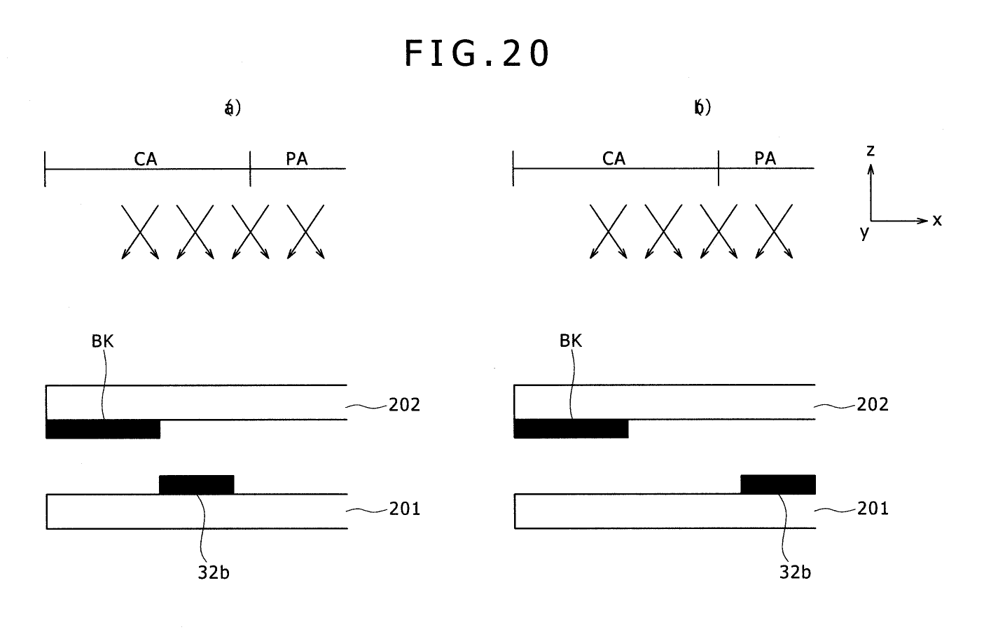

FIGS. 18 to 20 are views illustrating a manner wherein external light comes in where the external light sensor elements 32b are formed in the display region PA and where the external light sensor elements 32b are formed in the peripheral region CA. Here, FIG. 18 is top plan views. FIGS. 19 and 20 are side elevational views showing parts of side faces.

As shown in FIGS. 18 and 19, a light parting plate HM is disposed on the front face of the liquid crystal panel 200. This light parting plate HM is formed from a light blocking material which blocks light. The light parting plate HM is open at a portion thereof corresponding to the display region PA and is disposed in such a manner as to cover part of the peripheral region CA. Therefore, as shown (a) of FIG. 18 and (a) of FIG. 19, where an external light sensor element 32b is disposed in the peripheral region CA, part of light to come into the external light sensor element 32b is sometimes blocked by the light parting plate HM. In particular, light to come into the external light sensor element 32b from the left side is blocked while only light to come into the external light sensor element 32b from the right side is received by the external light sensor element 32b as shown in (a) of FIG. 18 and (a) of FIG. 19. On the other hand, where an external light sensor element 32b is disposed in the display region PA, light to come into the external light sensor element 32b is not blocked by the light parting plate HM as shown (b) of FIG. 18 and (b) of FIG. 19.

Further, as shown in FIG. 20, a light blocking black layer BK is provided on the opposing substrate 202 of the liquid crystal panel 200. This light blocking black layer BK is formed similarly to the black matrix layer 21K and blocks light. Further, this light blocking black layer BK is formed in such a manner as to cover part of the peripheral region CA similarly to the light parting plate HM. Therefore, if an external light sensor element 32b is disposed in the peripheral region CA as shown in (a) of FIG. 20, then part of light to come into the external light sensor element 32b is sometimes blocked by the light blocking black layer BK. In particular, for example, light to come into the external light sensor element 32b from the left side is blocked while only light to come into the external light sensor element 32b from the right side is received by the external light sensor element 32b as shown in (a) of FIG. 20. On the other hand, if the external light sensor element 32b is disposed in the display region PA as shown in (b) of FIG. 20, then light to come into the external light sensor element 32b is not blocked by the light blocking black layer BK.

Therefore, in the present embodiment, by providing an external light sensor element 32b in the display region PA as described above, light of a high intensity can be received.

Accordingly, with the present embodiment, since the influence of external light to come into the display region PA can be adjusted with a high degree of accuracy, occurrence of a fault that the quality of the display image is deteriorated by the influence of external light can be prevented.

More particularly, in the present embodiment, an external light sensor element 32b for receiving external light including visible light is disposed in the display region PA, and the external light sensor element 32b detects the signal amplitude, which increases in proportion to the luminance of external light, as a voltage or current value. Thereafter, the control section 401 uses the detection data to carry out luminance adjustment of the backlight 300. Generally, in an environment wherein external light, particularly, sunlight, comes in, it is sometimes difficult to recognize an image because of reflection in the display region PA. However, in the present embodiment, the visible light source 301a of the backlight 300 is controlled so that, for example, light of a luminance higher than the reflection luminance is emitted as outgoing light. Therefore, occurrence of a fault that the quality of the display image deteriorates can be prevented.

Further, although, in a state wherein external light is dark as in the case of the dark, occurrence of deterioration of the picture quality is suppressed, in this instance, the luminance of visible light which the visible light source 301a of the backlight 300 irradiates as illuminating light is controlled so as to be dropped. In particular, in the present embodiment, after the external light sensor element 32b receives external light, for example, in case of use in the open in which the intensity of external light is high, operation of the backlight is controlled so as to raise the backlight luminance. On the other hand, in case of use in an environment wherein the intensity of external light is low as in the case of indoor use, operation of the backlight is controlled so as to establish a state wherein the backlight luminance is low. Therefore, with the present embodiment, power consumption can be reduced in addition to the effects described above.

Further, in the present embodiment, since it can be prevented that light such as external light is multiple-reflected in the display panel and stray light is generated, the accuracy in position detection can be improved. Further, with the present embodiment, since a touch panel of the resistance type is not provided, the overall thickness can be reduced.

Further, in the present embodiment, the operation of the infrared light source 301b when it emits infrared light is controlled by the control section 401 based on reception light data obtained by reception of light by the external light sensor element 32b. Here, the control section 401 controls such that, where the illuminance of the received light is high, the infrared light source 301b irradiates infrared light of a higher luminance, but where the illuminance of the received light is low, the infrared light source 301b irradiates infrared light of a lower luminance as described hereinabove (refer to FIG. 16). Therefore, the present embodiment further has a merit that the power consumption of the liquid crystal display apparatus can be reduced.

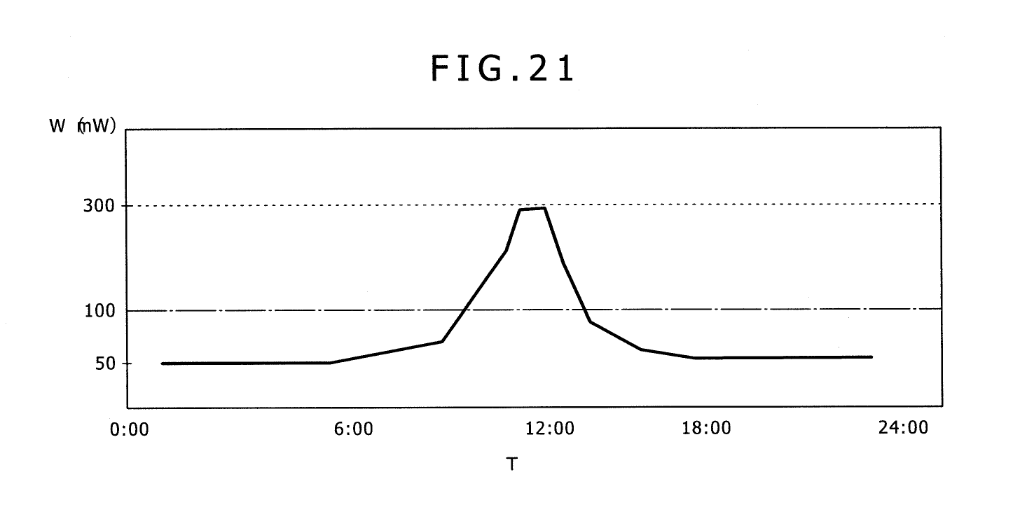

FIG. 21 is a view illustrating a relationship between the time T and the power consumption W (mW) of the infrared light source 301b of the backlight 300 in the embodiment 1 according to the present invention. Here, estimated values in regard to a case wherein the liquid crystal panel is a 3.5 type WVGA are illustrated.

Generally, natural light includes infrared light in an optical intensity substantially equal to that of visible light. Therefore, for example, when the time is approximately 12:00, natural light including infrared light of an intensity higher than that of reflected light of infrared light reflected by a detection object body such as a finger sometimes comes into the position sensor elements 32a, and it is sometimes difficult to carry out position detection of a detection object body with a high degree of accuracy. Therefore, in the present embodiment, high power (for example, 300 mW) is supplied to the infrared light source 301b based on reception light data obtained by reception of light by the external light sensor element 32b as illustrated in FIG. 21.

In contrast, where the time ranges from 0:00 to 12:00 or 18:00 to 24:00, since the optical intensity of natural light is low and indoor use is carried out frequently, external light does not include much infrared light. Therefore, for example, within the time zones, external light of an intensity higher than that of light of infrared light reflected by a detection object body comes in no case into the position sensor elements 32a, and position detection of a detection object body can be carried out with a high degree of accuracy without being influenced by external light. Therefore, in the present embodiment, power (for example, 50 mW) lower than that in the case described hereinabove is supplied to the infrared light source 301b based on reception light data obtained by reception of light by the external light sensor element 32b.

Conventionally, in order to prevent occurrence of a fault caused by coming in of natural light including infrared light of a high intensity, high power (for example, 300 mW) is supplied to the infrared light source 301b as indicated by a dotted line in FIG. 21. However, in the present embodiment, the power to be supplied to the infrared light source 301b is adjusted based on reception light data obtained by reception of light by the external light sensor element 32b. Therefore, as indicated by an alternate long and short dash line in FIG. 21, the value obtained by averaging the power consumption in the case of the present embodiment is lower than the value of conventional power consumption.

Accordingly, in the present embodiment, the power consumption can be reduced.

In addition, in the present embodiment, infrared light whose absorption factor by such members as a liquid crystal layer and a glass substrate is low are received by the position sensor elements 32a. Therefore, since the backlight luminance for obtaining an arbitrary detection signal can be made lower than that of visible light, the present embodiment can further reduce the power consumption.

Furthermore, in the present embodiment, the position sensor elements 32a and the external light sensor elements 32b are disposed such that they are juxtaposed alternately in each of the horizontal direction x and the vertical direction y. In other words, the external light sensor elements 32b are disposed uniformly over the overall display region PA. Therefore, the influence (panel surface luminance or the like) of incoming external light can be adjusted readily over the overall display region PA.

Further, the light receiving elements of the external light sensor elements for measuring the amount of visible light observed by the eyes of a human being accurately and feeding back the amount to the backlight for visible light and position sensor elements having a high S/N ratio can be formed by the same fabrication process.

### Embodiment 2

In the following, an embodiment 2 according to the present invention is described.

In the present embodiment, band gaps of semiconductor layers of the position sensor elements 32a and the external light sensor elements 32b are different from each other. Except this point, the present embodiment is similar to the embodiment 1. Therefore, description of overlapping portions is omitted.

In the present embodiment, a semiconductor layer in which the position sensor elements 32a receive and photoelectrically convert reflected light of a detection object body and another semiconductor layer in which the external light sensor elements 32b receive and photoelectrically convert external light have band gaps different from each other.

Here, the semiconductor layer in which photoelectric conversion is carried out by the position sensor elements 32a is formed such that it has a band gap narrower than that of the semiconductor layer in which photoelectric conversion is carried out by the external light sensor elements 32b.

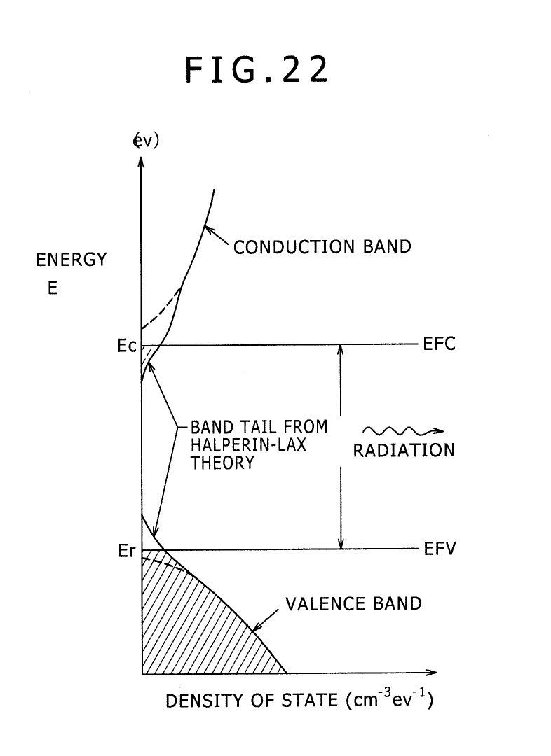

FIG. 22 is an explanatory view regarding the band gap of a silicon semiconductor in the embodiment 2 according to the present invention. Referring to FIG. 22, the axis of ordinate indicates the energy E (eV) and the axis of abscissa indicates the density of states (DENSITY OF STATES) (cm⁻³ eV⁻¹). It is to be noted that this figure is cited from “S. M. SZE, Physics of Semiconductor Devices, USA, John Wiley & Sons Inc, 1981/09 2^{nd} Edition, page 722, FIG. 40.” It is to be noted that FIG. 22 is an explanatory view of a concept of a band gap, and the band gap is represented by an expression of EFC−EFV=hν=hx1/λ=Eg.

The position sensor element 32a receives infrared light included in reflected light reflected from a detection object body. Therefore, the semiconductor layer in which photoelectric conversion is carried out by the position sensor element 32a is formed from polycrystalline silicon or crystalline silicon whose band gap is narrow as shown in FIG. 22. This semiconductor layer is formed such that, for example, the band gap is 1.1 eV.

On the other hand, the external light sensor element 32b receives visible light defined by a wavelength range from 350 nm to 700 nm. Therefore, the semiconductor layer in which photoelectric conversion is carried out by the external light sensor element 32b is formed from amorphous silicon or microcrystalline silicon wherein the optical band gap is distributed broadly. This semiconductor layer is formed such that, for example, the band gap is 1.6 eV.

In this manner, in the present embodiment, the semiconductor layer in which photoelectric conversion is carried out by the position sensor elements 32a is formed such that it has a band gap narrower than that of the semiconductor layer in which photoelectric conversion is carried out by the external light sensor elements 32b. Therefore, in the present embodiment, infrared light included in reflection light reflected by a detection object body can be received with a high sensitivity by the position sensor elements 32a. Meanwhile, visible light included in external light can be received with a high sensitivity by the external light sensor element 32b.

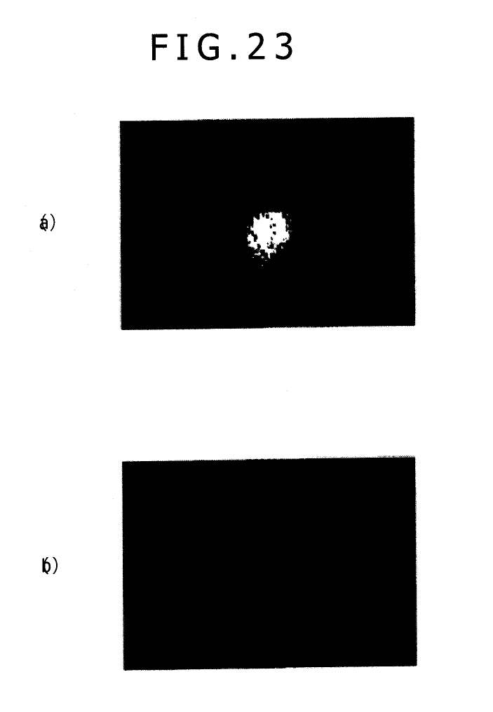

FIG. 23 is views illustrating an effect that position coordinate detection is carried out using infrared light in the embodiment 2 according to the present invention. Referring to FIG. 23, (a) shows a position information detection image obtained from reception light data produced through reception of infrared light in the display region PA as in the present embodiment. Further, referring to FIG. 23, (b) shows a position information detection image obtained from reception light data produced by reception only of visible light in the display region PA. Here, a portion from which the reception data is obtained is represented by a white color, and any other portion is indicated by a black color.

As shown in FIG. 23, where infrared light is used in the present embodiment (refer to (a) of FIG. 23), a detection object body can be detected, different from an alternative case wherein visible light is used without using infrared light (refer to (b) of FIG. 23).

Accordingly, with the present embodiment, since the influence of external light to come into the display region PA can be adjusted with a high degree of accuracy, occurrence of a fault that the quality of the display image is determined by an influence of external light can be prevented. Further, since it can be prevented that light such as external light is multiple-reflected in the display panel and stray light is generated, the accuracy in position detection can be improved.

### Embodiment 3

In the following, an embodiment 3 according to the present invention is described.

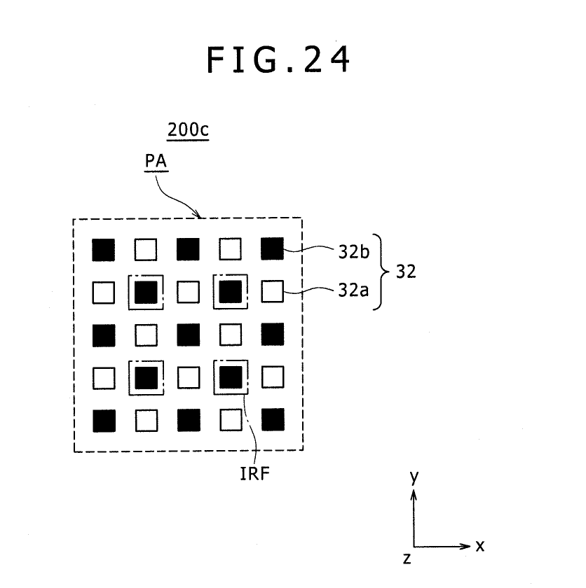

FIG. 24 is a plan view schematically illustrating a manner wherein light receiving elements 32 are disposed in a display region PA in a liquid crystal panel 200c in the embodiment 3 according to the present invention.

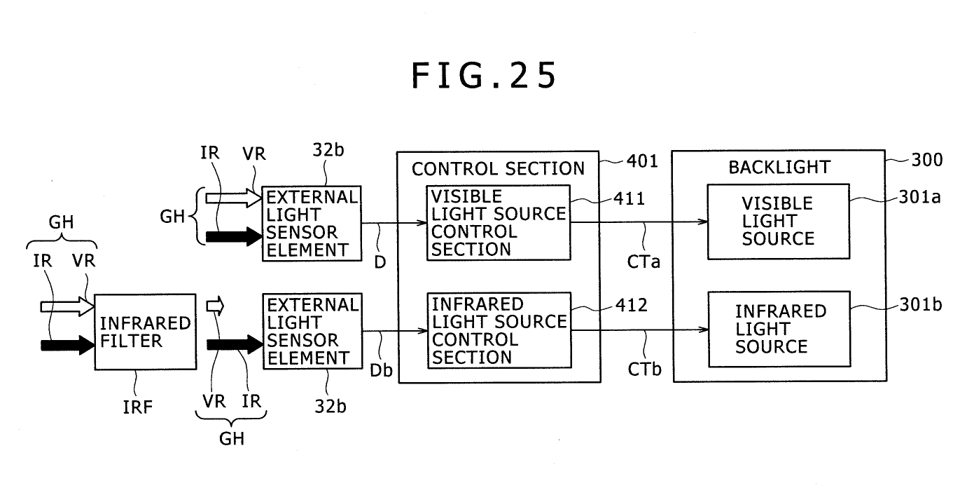

Meanwhile, FIG. 25 is a block diagram conceptually illustrating inputting/outputting of data between principal components of a control section 401 and other members in the embodiment 3 according to the present invention.

The present embodiment is different from the embodiment 1 in that an infrared filter IRF is provided so as to correspond to some of external light sensor elements 32b of the light receiving elements 32. Further, the present embodiment is different from the embodiment 1 in part of a relationship between the principal components of the control section 401 and inputting/outputting of data to/from the other members. Except this point, the present embodiment is similar to the embodiment 1. Therefore, description of overlapping portions is omitted.

The light receiving elements 32 are described.

As shown in FIG. 24, a plurality of position sensor elements 32a and a plurality of external light sensor elements 32b from among the light receiving elements 32 are disposed in the display region PA such that they may indicate a diced pattern similarly as in the case of the embodiment 1. In other words, a plurality of position sensor elements 32a and a plurality of external light sensor elements 32b are disposed such that they are juxtaposed alternately in each of the horizontal direction x and the vertical direction y.

Here, as shown in FIG. 24, an infrared filter IRF is provided for some of the plural external light sensor elements 32b while no infrared filter IRF is provided for the other remaining external light sensor elements 32b. For example, the infrared filters IRF are disposed such that presence and absence of disposition of an infrared filter IRF may appear alternately in the horizontal direction x and the vertical direction y as shown in FIG. 24.

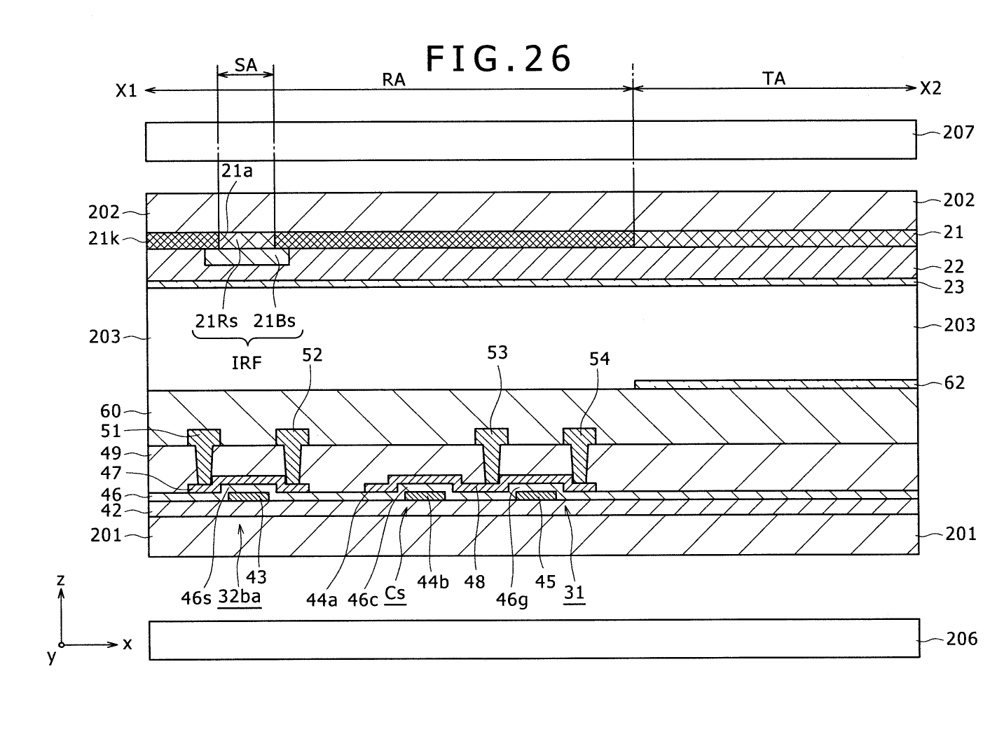

FIG. 26 is a sectional view schematically showing an outline of a portion at which an infrared filter IRF is provided from within a pixel P provided in the display region PA of the liquid crystal panel 200c in the embodiment 3 of the present invention. FIG. 26 shows a first external light sensor element 32ba of an external light sensor element 32b in which an infrared filter IRF is provided at a portion corresponding to an X1-X2 portion in FIG. 5 similarly to FIG. 8.

It is to be noted that, though not shown, in the external light sensor element 32b in which the infrared filter IRF is provided, a second external light sensor element 32bb is provided separately from the first external light sensor element 32ba similarly as in FIG. 9.

As shown in FIG. 26, the infrared filter IRF is formed on a face of the opposing substrate 202 on the side opposing to the TFT array substrate 201 and is configured such that infrared light passes therethrough more than visible light.

Here, the infrared filter IRF includes a red filter layer 21Rs and a blue filter layer 21Bs as shown in FIG. 26, and the red filter layer 21Rs and the blue filter layer 21Bs are successively layered from the opposing substrate 202 side.

In the present embodiment, the infrared filter IRF is provided in the opening 21a provided in the black matrix layer 21K on the opposing substrate 202.

This infrared filter IRF is formed at a step same as the step at which the red filter layer 21R and the blue filter region 21B which form the color filter layer 21 are formed.

For example, coating liquid including a coloring pigment of red and a photo resist material is applied by spin coating to the overall area including formation regions of the red filter layer 21R of the color filter layer 21 and the red filter layer 21Rs of the infrared filter IRF to form a red resist film (not shown). Then, the red resist film is patterned by a lithography technique to form the red filter layer 21R of the color filter layer 21 and the red filter layer 21Rs of the infrared filter IRF.

Thereafter, coating liquid including a coloring pigment of blue and a photo resist material is applied by spin coating to the overall area including formation regions of the blue filter layer 21B of the color filter layer 21 and the blue filter layer 21Bs of the infrared filter IRF to form a blue resist film (not shown). Then, the blue resist film is patterned by a lithography technique to form the blue filter layer 21B of the color filter layer 21 and the blue filter layer 21Bs of the infrared filter IRF. Here, the patterning is carried out such that the blue filter layer 21Bs is layered on the red filter layer 21Rs.

It is to be noted that visible light VR can be absorbed suitably by layering at least two from among a red filter layer, a green filter layer and a blue filter layer for the three primary colors. Therefore, the configuration of the color filter laminate 21ST is not limited to that which is formed using a red filter layer and a blue filter layer. For example, all of a red filter layer, a green filter layer and a blue filter layer for the three primary colors may be layered to form the color filter laminate 21ST.

The control section 401 is described.

As shown in FIG. 25, in the control section 401, the visible light source control section 411 receives reception light data D obtained by reception of external light GH including visible light VR and infrared light IR by the external light sensor element 32b similarly as in the case of the embodiment 1. Thereafter, the visible light source control section 411 outputs control data CTa to the visible light source 301a in response to the reception light data D to control operation of the visible light source 301a.

For example, in the visible light source control section 411, a lookup table wherein control data CTa representative of a value of power to be supplied to the visible light source 301a and reception light data D are associated with each other is stored in the memory (not shown) similarly as in the embodiment 1. The infrared light source control section 412 uses this lookup table, and the visible light source control section 411 controls.

On the other hand, in the control section 401, the infrared light source control section 412 receives reception light data Db obtained by reception of external light GH incoming through the infrared filter IRF by the external light sensor element 32b, different from the case of the embodiment 1 as illustrated in FIG. 25. As illustrated in FIG. 25, external light GH including visible light VR and infrared light IR comes into the infrared filter IRF. Thereafter, the infrared light IR included in the external light GH passes through the infrared filter IRF more than the visible light VR. Therefore, the external light sensor element 32b receives the external light GH in which much infrared light IR is included and produces reception light data Db. Then, the infrared light source control section 412 outputs control data CTb to the infrared light source 301b in response to the reception light data Db to control operation of the infrared light source 301b.

For example, in the infrared light source control section 412, a lookup table wherein control data CTb indicative of a value of power to be supplied to the infrared light source 301b and reception light data Db are associated with each other is stored in a memory (not shown). The infrared light source control section 412 uses the lookup table and the visible light source control section 411 controls.

As described above, in the present embodiment, the infrared light source control section 412 controls operation of the infrared light source 301b based on the reception light data Db produced by reception of external light GH which includes much infrared light IR by the external light sensor element 32b. Therefore, since the illuminance of infrared light can be controlled with a high degree of accuracy, detection of a detection object body such as a finger can be carried out with a high degree of accuracy. Further, together with this, increase of power consumption can be suppressed, similarly as in the embodiment 1.

It is to be noted that, in carrying out the present invention, it is not limited to the embodiments described above, but various modified forms can be adopted. In other words, various particular items of the invention can be altered or combined suitably.

For example, while, in the present embodiments described above, a PIN sensor is provided in the light receiving elements 32, the present invention is not limited to this. For example, even if a PDN sensor including a photodiode of a PDN (P Doped−N+N type) structure is formed as the light receiving element 32, similar effects can be exhibited. In addition, for example, a phototransistor may be formed as the light receiving element 32.

Further, while, in the embodiments described above, illuminating light is irradiated such that it includes invisible light such as infrared light, the present invention is not limited to this. For example, the present invention can be applied also where illuminating light which includes only visible light without including invisible light is irradiated. Incidentally, invisible light signifies infrared light of a wavelength longer than 700 nm and ultraviolet light of a wavelength of 10 nm to 400 nm.

Further, while, in the embodiments described above, illuminating light is irradiated such that it includes infrared light as invisible light, the present invention is not limited to this. For example, illuminating light may be irradiated such that it includes ultraviolet light as invisible light.

Further, while, in the embodiments described above, the pixel switching element 31 is formed as a thin film transistor of the bottom gate type, the present invention is not limited to this.

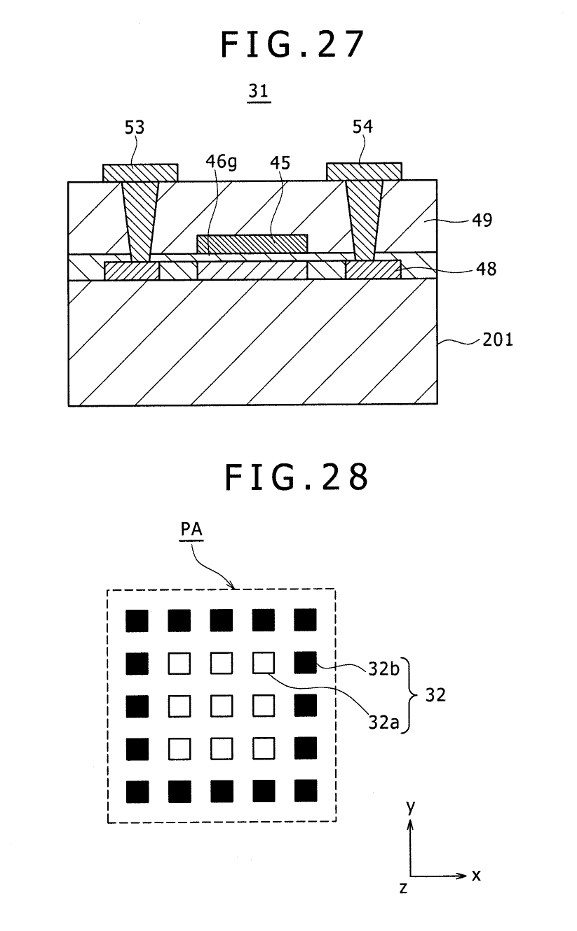

FIG. 27 is a sectional view showing a modified form of the configuration of the pixel switching element 31 in the embodiments according to the present invention.

As shown in FIG. 27, for example, a TFT of the top gate type may be formed as the pixel switching element 31.

Further, while, in the embodiments described above, a plurality of light receiving elements 32 are provided so as to correspond to a plurality of pixels P, the present invention is not limited to this. For example, one light receiving element 32 may be provided for a plurality of pixels P, or conversely a plurality of light receiving elements 32 may be provided for one pixel P.

Further, in the embodiments described above, the light receiving elements 32 which function as position sensor elements 32a and external light sensor elements 32b are disposed in the display region PA such that the position sensor elements 32a and the external light sensor elements 32b exhibit a diced pattern as shown in FIG. 3. However, the present invention is not limited to this.

FIG. 28 is a plan view schematically illustrating a manner wherein light receiving elements are disposed as position sensor elements or external light sensor elements in the display region PA in the embodiments according to the present invention.

As shown in FIG. 28, a plurality of position sensor elements 32a may be disposed in the middle of the display region PA while a plurality of external light sensor elements 32b are disposed along peripheries of the display region PA in such a manner as to surround the position sensor elements 32a.

In this instance, the second external light sensor element 32bb for receiving light coming in through a black matrix for blocking light from among the external light sensor elements 32b is not formed at the center of the display region PA but is formed around the same. Therefore, since the luminance of the display image does not drop, the image quality can be improved.

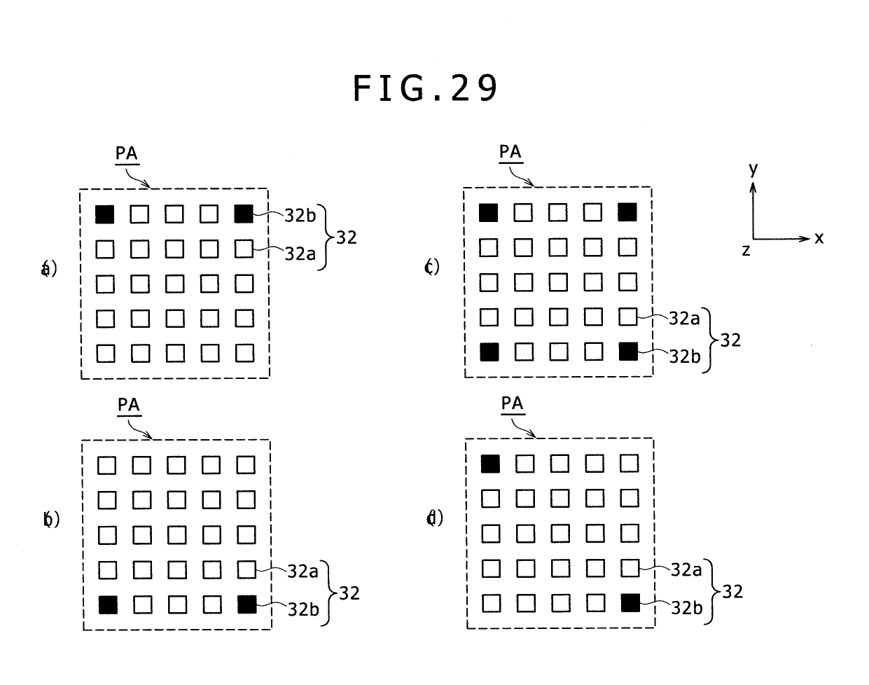

FIG. 29 is plan views schematically illustrating manners wherein light receiving elements are disposed as position sensor elements or external light sensor elements in the display region PA in the embodiments according to the present invention.

As shown in FIG. 29, an external light sensor element 32b may be disposed at any of four corner portions of the display region PA of a rectangular shape while position sensor elements 32a are disposed in the other region.

In particular, an external light sensor element 32b may be disposed at two corner portions at an upper portion from among four corner portions of the display region PA of a rectangular shape as shown in (a) of FIG. 29. Or, an external light sensor element 32b may be disposed at two corner portions at a lower portion from among four corner portions of the display region PA of a rectangular shape as shown in (b) of FIG. 29. Or else, an external light sensor element 32b may be disposed at all of four corner portions of the display region PA of a rectangular shape as shown in (c) of FIG. 29. Or otherwise, an external light sensor element 32b may be disposed at two diagonal corner portions from among four corner portions of the display region PA of a rectangular shape as shown in (d) of FIG. 29. Or, though not shown, an external light sensor element 32b may be disposed at one of four corner portions of the display region PA of a rectangular shape.

Also in this instance, the image quality can be improved similarly as described above.

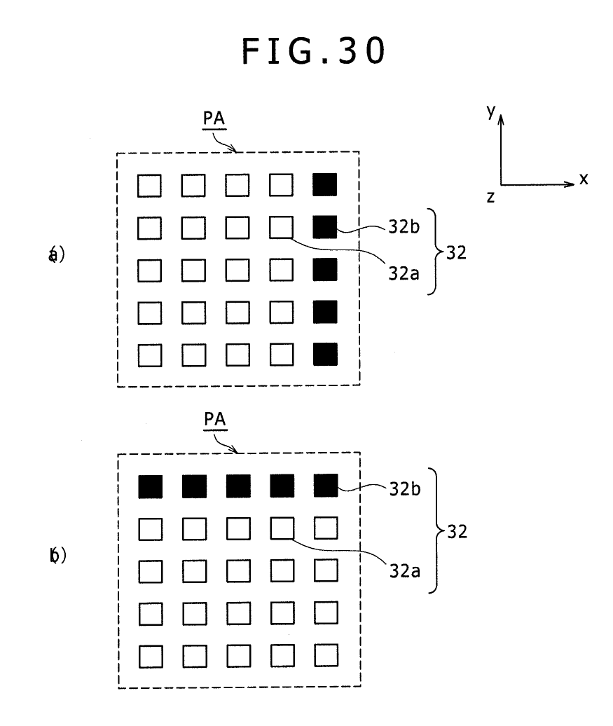

FIG. 30 is plan views schematically illustrating manners wherein light receiving elements are disposed as position sensor elements or external light sensor elements in the display region PA in the embodiments according to the present invention.

As shown in FIG. 30, external light sensor elements 32b may be disposed along one side which defines a display region PA of a rectangular shape while position sensor elements 32a are disposed at other positions.

In particular, a plurality of external light sensor elements 32b may be disposed along a side extending in the vertical direction from among four sides which define a display region PA of a rectangular shape as shown in (a) of FIG. 30. Or, a plurality of external light sensor elements 32b may be disposed along a side extending in the horizontal direction from among four sides which define a display region PA of a rectangular shape as shown in (b) of FIG. 30.

Also in this instance, the image quality can be improved similarly as described above. Further, external light to come into the external light sensor element 32b is sometimes blocked by a housing which is installed so as to surround the display region PA. However, if a plurality of external light sensor elements 32b are disposed along a side which is less likely to be influenced by the housing, then external light can be received precisely. Therefore, control of later operation of the backlight 300 can be carried out appropriately.

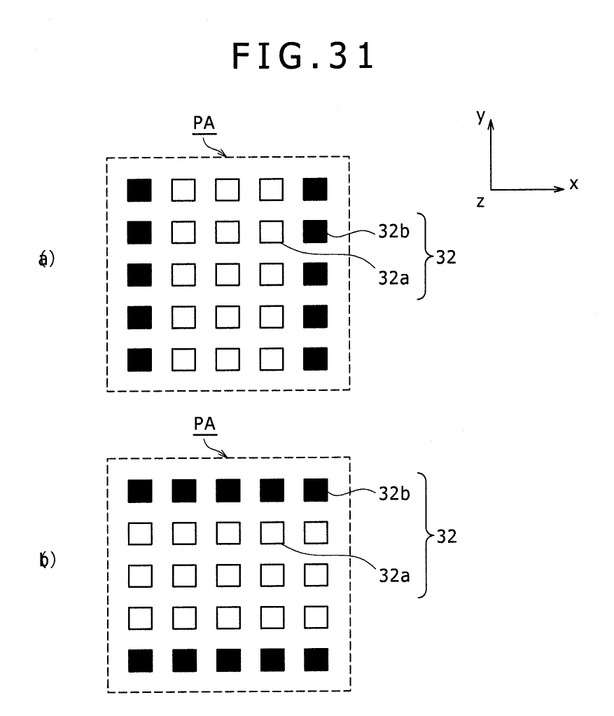

FIG. 31 is plan views schematically illustrating manners wherein a light receiving element is disposed as a position sensor element or an external light sensor element in a display region PA in the embodiments according to the present invention.

As shown in FIG. 31, external light sensor elements 32b may be disposed along two sides which define a display region PA of a rectangular shape and extend in parallel to each other while position sensor elements 32a are disposed at other positions.

In particular, a plurality of external light sensor elements 32b may be disposed along two sides extending in the vertical direction from among four sides which define a display region PA of a rectangular shape as shown in (a) of FIG. 31. Or, a plurality of external light sensor elements 32b may be disposed along two sides extending in the horizontal direction from among four sides which define a display region PA of a rectangular shape as shown in (b) of FIG. 31.

Also in this instance, similar effects to those described hereinabove can be obtained.

Further, the liquid crystal display apparatus 100 of the present embodiments can be applied as apart of various electronic apparatus.

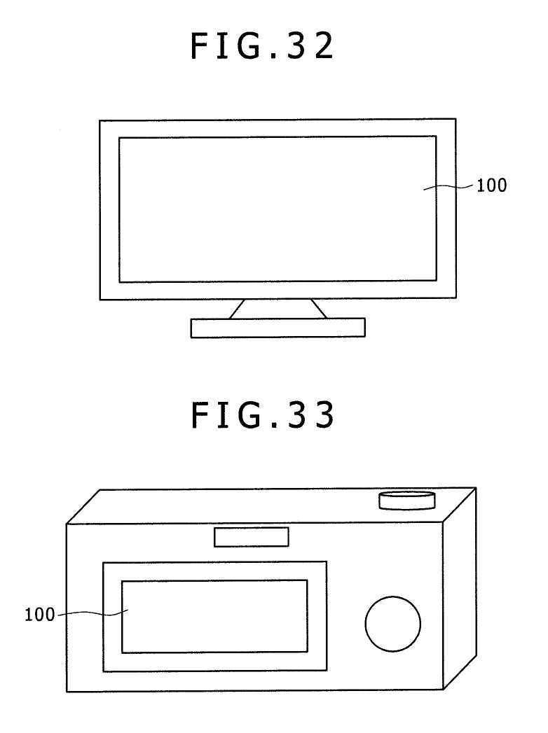

FIGS. 32 to 36 are views showing electronic apparatus to which the liquid crystal display apparatus 100 of any embodiment according to the present invention is applied.

As shown in FIG. 32, the liquid crystal display apparatus 100 can be applied as a display apparatus for a television receiver for receiving and displaying a television broadcast wherein a received image is displayed on the display screen and an operation instruction of an operator is inputted.

As shown in FIG. 33, the liquid crystal display apparatus 100 can be applied as a display apparatus for a digital still camera wherein an image such as a picked up image by the digital still camera is displayed on the display screen and an operation instruction of an operator is inputted.

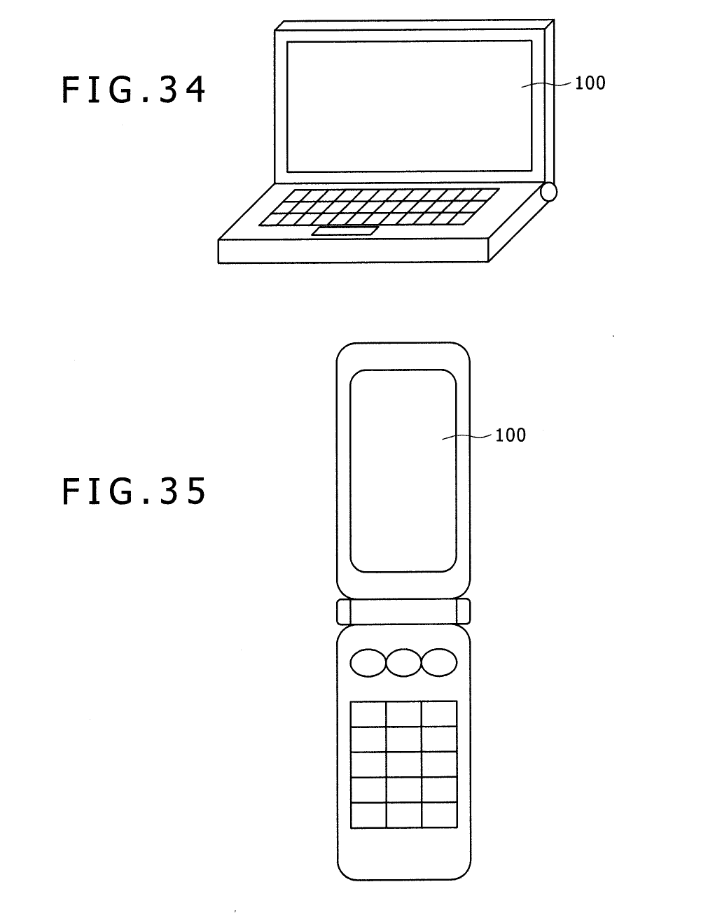

As shown in FIG. 34, the liquid crystal display apparatus 100 can be applied as a display apparatus for a notebook type personal computer wherein an image such as an operation image is displayed on the display screen and an operation instruction of an operator is inputted.

As shown in FIG. 35, the liquid crystal display apparatus 100 can be applied as a display apparatus for a portable telephone set wherein an image such as an operation image is displayed on the display screen and an operation instruction of an operator is inputted.

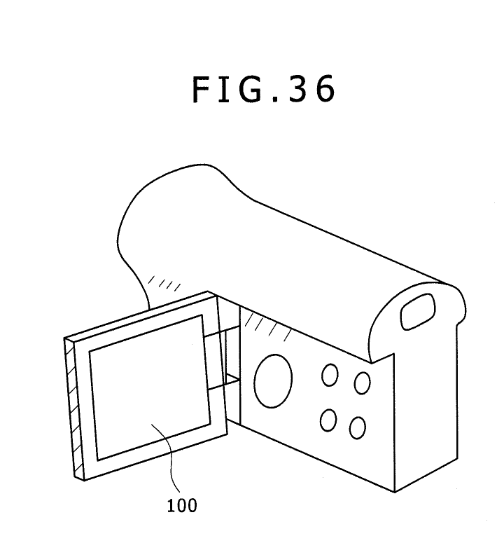

As shown in FIG. 36, the liquid crystal display apparatus 100 can be applied as a display apparatus for a video camera wherein an image such as an operation image is displayed on the display screen and an operation instruction of an operator is inputted.

Further, while, in the embodiments described above, the plural light receiving elements 32 provided in the display region PA are configured such that each of them functions as one of the position sensor elements 32a and the external light sensor element 32b, the present invention is not limited to this. The plural light receiving elements 32 provided in the display region PA may be formed otherwise such that each of them functions as both of the position sensor elements 32a and the external light sensor element 32b. In other words, each light receiving element may be configured so as to serve as both of the position sensor element 32a and the external light sensor element 32b. For example, a switch for switching each light receiving element such that reception light data obtained when the light receiving element functions as the position sensor element 32a is outputted to the position detection section 402 but reception data obtained when the light receiving element functions as the external light sensor element 32b is outputted to the control section 401 is provided. Further, the switch may be configured such that operation thereof is controlled.

Further, while, in the embodiments described above, the first external light sensor element 32ba and the second external light sensor element 32bb are provided as the external light sensor elements 32b, the present invention is not limited to this. For example, similar effects can be obtained also where only the first external light sensor element 32ba is provided. Further, also the circuit configuration for obtaining reception light data from the external light sensor element 32b is not limited to the form described above. For example, a circuit configuration similar to that of the position sensor elements 32a may be applied.

Further, while, in the embodiments described hereinabove, both of the first external light sensor element 32ba and the second external light sensor element 32bb as the external light sensor elements 32b are provided so as to correspond to each of the pixels P, the present invention is not limited to this. For example, one second external light sensor element 32bb may be disposed for two first external light sensor elements 32ba. In this instance, it is preferable to use a configuration wherein, for example, reception light data obtained from one second external light sensor element 32bb is subtracted from reception data obtained individually from the two first external light sensor elements 32ba. By this configuration, it is possible to reduce the occupation area of the light receiving elements, and therefore, the light transmission factor with which light is transmitted for image display can be improved. Further, one of the first external light sensor element 32ba and the second external light sensor element 32bb may be provided additionally so as to correspond to each of the pixels P. In this instance, the first external light sensor elements 32ba and the second external light sensor elements 32bb may be disposed so as to be juxtaposed alternately in each of the horizontal direction x and the vertical direction y.

Further, in the embodiments, the red filter layer 21R, green filter layer 21G and blue filter region 21B are formed in a stripe shape and are formed so as to be juxtaposed in the horizontal direction x. Further, the light receiving region SA is formed in the neighborhood of the red filter layer 21R such that it is juxtaposed with the red filter layer 21R, green filter layer 21G and blue filter region 21B (refer to FIG. 5). However, the present invention is not limited to this. For example, a red filter layer 21R, a green filter layer 21G, a blue filter region 21B and a light receiving region SA may be used to form one set such that the four elements of the red filter layer 21R, green filter layer 21G, blue filter region 21B and light receiving region SA are disposed in a 2×2 matrix.

Further, the present invention can be applied to liquid crystal panels of various types such as the IPS (In-Phase-Switching) type and the FFS (Field Fringe Switching) type. Furthermore, the present invention can be applied also to other display apparatus such as an organic EL display device and electronic paper.

It is to be noted that the position sensor element 32a in the embodiments described hereinabove corresponds to the position sensor element in the present invention. Further, the external light sensor element 32b in the embodiments described hereinabove in the embodiments described hereinabove corresponds to the external light sensor element in the present invention. Further, the liquid crystal display apparatus 100 in the embodiments described hereinabove corresponds to the display apparatus in the present invention. Further, the liquid crystal panel 200 in the embodiments described hereinabove corresponds to the display panel in the present invention. Further, the backlight 300 in the embodiments described hereinabove corresponds to the illuminating section in the present invention. Further, the TFT array substrate 201 in the embodiments described hereinabove corresponds to the first substrate in the present invention. Further, the opposing substrate 202 in the embodiments described hereinabove corresponds to the second substrate in the present invention. Further, the liquid crystal layer 203 in the embodiments described hereinabove corresponds to the liquid crystal layer in the present invention. Further, the control section 401 in the embodiments described hereinabove corresponds to the control section in the present invention. Further, the position detection section 402 in the embodiments described hereinabove corresponds to the position detection section in the present invention. Further, the display region PA in the embodiments described hereinabove corresponds to the display region in the present invention. Further, the infrared filter IRF in the embodiments described hereinabove corresponds to the invisible light filter in the present invention. Further, the visible light source control section 411 in the embodiments described hereinabove corresponds to the visible light source control section in the present invention. Further, the infrared light source control section 412 in the embodiments described hereinabove corresponds to the invisible light source control section in the present invention.

1. A display apparatus, comprising:
a display panel having a plurality of pixels disposed in a display region;
an illuminating section for emitting illuminating light from one face side of said display panel to said display region;
an external light sensor element for receiving light coming in from the other face side of said display panel; and
a control section for controlling operation of said illuminating section to emit the illuminating light based on reception light data obtained by reception of the light by said external light sensor element;
said external light sensor element being disposed in said display region.

2. The display apparatus according to claim 1, further comprising:
a plurality of position sensor elements disposed in said display region for receiving light reflected by a detection object body on the other face side of said display panel; and
a position detection section for detecting the position of said detection object body in said display region based on reception light data obtained by reception of the light by said position sensor elements.

3. The display apparatus according to claim 2, wherein:
said illuminating section has an invisible light source for emitting invisible light and is configured so as to emit at least said invisible light as said illuminating light;
said position sensor elements receive light of said invisible light reflected by the detection object body on the other face side of said display panel; and
said control section has an invisible light source control section for controlling operation of said invisible light source to emit the invisible light based on said reception light data.

4. The display apparatus according to claim 3, wherein said invisible light source control section controls operation of said invisible light source such that, where the luminance of the light received by said external light sensor element is high, the luminance of the invisible light to be emitted from said invisible light source is higher than that where the luminance is low.

5. The display apparatus according to claim 3, wherein
said illuminating section has a visible light source for emitting visible light and is configured so as to emit said visible light as said illuminating light;
said display panel is a liquid crystal panel of the transmission type and carries out image display in said display region with said visible light irradiated from said visible light source upon said display region; and
said control section has a visible light source control section for controlling operation of said visible light source to emit the visible light and operation of said invisible light source to emit the invisible light based on said reception light data.

6. The display apparatus according to claim 5, wherein
said visible light source control section controls the operation of said visible light source such that, where the luminance of the light received by said external light sensor element is high, the luminance of the visible light to be emitted from said visible light source is higher than that where the luminance is low; and
said invisible light source control section controls the operation of said invisible light source such that, where the luminance of the light received by said external light sensor element is high, the luminance of the invisible light to be emitted from said invisible light source is higher than that where the luminance is low.

7. The display apparatus according to claim 5, further comprising:
an invisible light filter which transmits said invisible light more than said visible light, wherein
a plurality of said external light sensor elements are disposed in said display region and are configured such that some of said external light sensor elements receive light coming in through said invisible light filter;
said invisible light source control section controls the operation of said invisible light source to emit the invisible light based on reception light data obtained by reception of the light coming in through said invisible light filter; and
said visible light source control section controls the operation of said visible light source to emit the visible light based on reception light data obtained by reception of light coming in without passing through said invisible light filter.

8. The display apparatus according to claim 7, wherein
said invisible light source control section controls the operation of said invisible light source such that, where the luminance of the light coming in through said invisible light filter is high, the luminance of the invisible light to be emitted from said invisible light source is higher than that where the luminance is low; and
said visible light source control section controls the operation of said visible light source such that, where the luminance of the light coming in without passing through said invisible light filter is high, the luminance of the visible light to be emitted from said visible light source is higher than that where the luminance is low.

9. The display apparatus according to any one of claims 1 to 8, wherein said invisible light source is configured so as to emit infrared light as said invisible light.

10. The display apparatus according to claim 7, wherein
said external sensor element has a first semiconductor layer for receiving and photoelectrically converting light coming in from the other face side of said display panel;
said position sensor element has a second semiconductor layer for receiving and photoelectrically converting light coming in from the other face side of said display panel; and
said second semiconductor layer is formed such that a band gap thereof is narrower than that of said first semiconductor.

11. The display apparatus according to claim 10, wherein said first semiconductor layer is made of amorphous silicon or microcrystalline silicon, and said second semiconductor layer is made of polycrystalline silicon or crystalline silicon.
